(19) United States
(12) Patent Application Publication
(10) Pub. No.: US 2008/0177777 A1
(43) Pub. Date: Jul. 24, 2008

(54) DATABASE MANAGEMENT METHOD, PROGRAM THEREOF AND DATABASE MANAGEMENT APPARATUS

(76) Inventors: Kazuhiro Osaki, Yokohama (JP); Norihiro Hara, Kawasaki (JP); Michio Iljima, Tokyo (JP); Natsuko Sugaya, Inagi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/860,632

(22) Filed: Sep. 25, 2007

(30) Foreign Application Priority Data
Jan. 18, 2007 (JP) 2007-009371

(51) Int. Cl. G06F 17/30

(52) U.S. Cl. 707/102; 707/E17.044

(57) ABSTRACT

Upon receiving XML data input, a database management system calculates a processing cost for reflecting the XML data to an index. If the calculated processing cost exceeds a predetermined threshold, the database management system stores structure analysis information concerning the XML data in a structure analysis information storage area. When an input of a retrieval request of the structured data containing a structure condition of the structured data is accepted and structured data that is an object of the retrieval request is structured data that is not reflected to the index, the database management system takes out structure analysis information stored in the structure analysis information storage area, discriminates a range of XML data that becomes the object of the retrieval request, and conducts retrieval over the range.

### INCORPORATION BY REFERENCE

The present application claims priority from Japanese application JP2007-009371 filed on Jan. 18, 2007, the content of which is hereby incorporated by reference into this application.

### BACKGROUND OF THE INVENTION

The present invention relates to a technique for registering and retrieving structured data.

In recent years, needs for retrieving required information from electronized documents fast reliably have increased. There is a full text retrieval system as a system that meets such needs. In the full text retrieval system, a computer system can retrieve documents containing specified characters from a database of documents. Furthermore, the full text retrieval system is also sophisticated. Not only retrieval in conventional flat documents, but also retrieval with a structure specified in structured documents (structured data) such as XML (Extensible Markup Language) data is made possible (see JP-A-10-240752). For example, information containing an author name “A” is retrieved from information in the range of “<bibliography>” to “</bibliography>” in documents described with XML. In this way, retrieval with a document structure specified has become possible.

As a technique for raising the speed of the full text retrieval, there is a technique using an n-gram index. With respect to n connected characters (n-gram), the n-gram index indicates a position in a document in which the n characters appear, as an index. In structured documents such as XML data as well, it is possible to manage in which structure of the XML data the connected characters appear, by using the n-gram index.

The computer system can retrieve information at high speed by using the n-gram index. However, there is a problem that it takes time to conduct index (full text retrieval index) such as additional registration of indexes.

Therefore, the following technique is proposed in order to make it possible to retrieve documents without spending the update processing time of the full text retrieval index. In other words, when newly registering a document, the computer first stores the document at it is in an update text buffer. When the computer retrieves documents, the computer retrieves both documents stored in the update text buffer and indexes in the full text retrieval index. In other words, the computer conducts text scan on documents stored in the update text buffer and retrieves an index containing a specified character string on the full text retrieval index.

Separately from the retrieval processing (for example, while the computer is not conducting the retrieval processing), the computer updates the full text retrieval index on the basis of documents in the update text buffer. By the way, the update of the full text retrieval index is conducted in response to a command input from a system manager or storage of documents exceeding a predetermined number in the update text buffer (see JP-A-10-240754).

### SUMMARY OF THE INVENTION

However, the technique described in JP-A-10-240754 has a problem that an increase of the number of documents registered in the update text buffer causes an increase of retrieval processing time for documents stored in the update text buffer. In other words, there is a problem that it takes a considerably long time if the computer executes retrieval processing in a state in which a large number of documents for each of which an index has not yet been generated are stored in the update text buffer. This problem is also posed in the same way when the technique for retrieving structured data described in JP-A-10-240752 is used in the technique described in JP-A-10-240754.

An object of the present invention is to solve the problem and raise the speed of data retrieval without increasing the structured data registration time, in a document retrieval system for structured data such as XML data.

In order to solve the problem, a computer for retrieving structured data by using an index according to the present invention accepts input of structured data and conducts structure analysis on the input structured data. In other words, the computer analyzes names of structure elements included in the structured data, relations among the structure elements, and appearance locations, in the structured data, of the structure elements. Subsequently, the computer calculates a processing cost for reflecting the structured data to the index on the basis of the generated structure analysis information. For example, the computer calculates a registration processing time required to reflect the structured data to the index. When the calculated processing cost exceeds the predetermined threshold, the computer stores structure analysis information concerning the structured data in a storage. In other words, the computer only stores the structure analysis information in the storage, and does not reflect the input structured data to the index. When the computer accepts an input of a retrieval request containing a structure condition and structured data that is an object of the retrieval request is structured data that is not reflected to the index, the computer conducts retrieval processing described hereafter. First, the computer reads out an appearance location, in the structured data, of a structure element satisfying the structure condition from the structure analysis information stored in the storage. And the computer retrieves data satisfying the retrieval request from data in the appearance location read out. For example, the computer conducts test scan.

In this way, the computer stores structured data that takes a long time to conduct index reflection (index update) in the storage at a stage in which structure analysis information is generated. In other words, index update based on the structure analysis information is not conducted. On the other hand, as for structured data that does not take a long time to update the index, the computer generates structure analysis information and then conducts index update on the basis of the structure analysis information.

When conducting retrieval in structured data that are not yet reflected to the index, the computer judges which range of structured data unreflected to the index should be a retrieval object on the basis of information indicated in the structure analysis information (information such as names of structure elements included in the structured data, relations among the structure elements, and appearance locations, in the structured data, of the structure elements), and narrows down the retrieval range. And the computer retrieves data satisfying a retrieval request over the range narrowed down. For example, the computer retrieves data containing a character string specified in the retrieval request over the predetermined range of structured data. Therefore, the computer can conduct retrieval faster as compared with the case where the computer conducts character string retrieval in all structured data unreflected to the index. Furthermore, the computer can conduct retrieval fast by using the index for structured data already reflected to the index as well. In other words, the speed of data retrieval can be raised without increasing the registration time of structured data.

According to the present invention, the speed of data retrieval can be raised without increasing the structured data registration time, in a document retrieval system for structured data such as XML data.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a configuration example of a system including a database management system according to a first embodiment;

FIG. 2 is a diagram showing an example of unreflected data management information shown in FIG. 1;

FIG. 3A is a diagram showing an example of XML data which becomes an object of structure analysis;

FIG. 3B is a diagram showing an example of structure analysis information of the XML data shown in FIG. 3A;

FIG. 4 is a diagram for explaining outline of the database management system shown in FIG. 1;

FIG. 5A is a flow chart showing an operation procedure in the database management system shown in FIG. 1;

FIG. 5B is a flow chart showing an operation procedure in an index registration processor shown in FIG. 1;

FIG. 6 is a flow chart showing an operation procedure in the database management system shown in FIG. 1;

FIG. 7 is a diagram showing a configuration example of a system including a database management system according to a second embodiment;

FIG. 8A is a flow chart showing an operation procedure in the database management system shown in FIG. 7;

FIG. 8B is a flow chart showing an operation procedure in an index registration processor shown in FIG. 7;

FIG. 9 is a diagram showing a configuration example of a system including a database management system according to a third embodiment;

FIG. 10 is a diagram showing an example of structure analysis information processed by the database management system shown in FIG. 9;

FIG. 11 is a flow chart showing an operation procedure in an index registration processor shown in FIG. 9;

FIG. 12 is a diagram showing a configuration example of a system including a database management system according to a fourth embodiment or a fifth embodiment;

FIG. 13A is a flow chart showing an operation procedure in the database management system shown in FIG. 12;

FIG. 13B is a flow chart showing an operation procedure in an index registration processor shown in FIG. 12;

FIG. 14 is a flow chart showing an operation procedure in a database access controller shown in FIG. 12;

FIG. 15 is a diagram showing an example of a selection input screen of XML data which is an index reflection object in the fifth embodiment;

FIG. 16 is a diagram showing a configuration example of a system including a database management system according to a sixth embodiment;

FIG. 17 is a diagram showing an example of unreflected data management information shown in the sixth embodiment;

FIG. 18 is a flow chart showing on operation procedure in the database management system shown in FIG. 16 at the XML data retrieval;

FIG. 19 is a flow chart showing an operation procedure in the database management system shown in FIG. 16;

FIG. 20 is a diagram showing an example of a selection input screen of XML data which is an index reflection object in the sixth embodiment; and

FIG. 21 shows an example of a setting screen displayed by a setting processor in the sixth embodiment.

### DESCRIPTION OF THE EMBODIMENTS

Hereafter, embodiments of the present invention will be described with reference to the drawings. In the ensuing description, the object of retrieval and registration in the present system is supposed to be XML data. However, the object may be other data as long as the data is structured data.

### First Embodiment

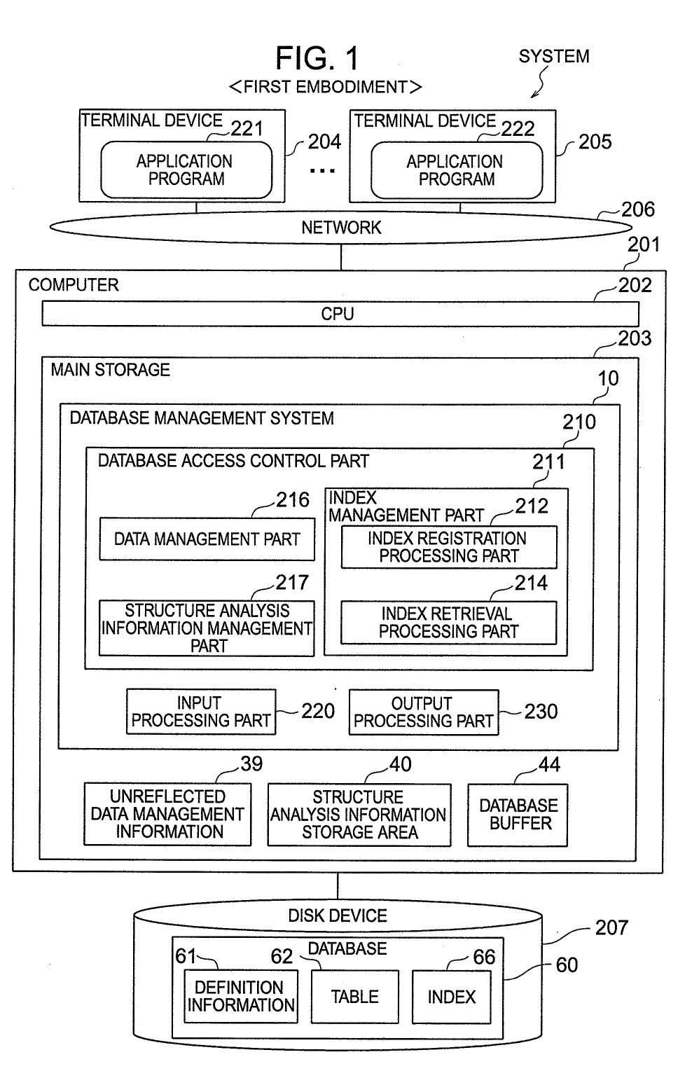

FIG. 1 is a diagram showing a configuration example of a system including a database management system according to a first embodiment. As shown in FIG. 1, the system includes terminal devices 204 and 205, a network 206, a computer (database management apparatus) 201 and a disk device 207.

The terminal devices 204 and 205 have application programs 221 and 222, respectively. The terminal devices 204 and 205 request the computer 201 to conduct various operation processing such as XML data registration or retrieval by using the application programs 221 and 222, respectively. The terminal devices 204 and 205 are connected to the computer 201 via the network 206 so as to be capable of conducting communication. Each of the terminal devices 204 and 205 is implemented by using, for example, a PC (personal computer). An input device (such as a keyboard and a mouse) and an output device (such as a liquid crystal display), which are not illustrated, are connected to each of the terminal devices 204 and 205. The network 206 is implemented by using, for example, the Internet or a LAN (local area network).

In the ensuing description, the terminal device 204 is supposed to be a terminal device that mainly registers XML data and the terminal device 205 is supposed to be a terminal device that mainly retrieves XML data. However, the terminal devices are not constrained to them. The number of terminal devices connected to the computer 201 is not restricted to the number exemplified in FIG. 1.

The computer 201 conducts various kinds of operation processing such as XML data registration and retrieval. The computer 201 includes a network interface, an input interface and an output interface (which are not illustrated). The computer 201 conducts communication with the terminal devices 204 and 205 via the network 206 by using the network interface. Furthermore, the computer 201 reads data from the disk device 207 and writes data into the disk device 207 via the input interface and the output interface.

The disk device 207 is a storage connected to the computer 201. The disk device 207 includes a database 60 of XML data. The disk device 207 is implemented by using, for example, a HDD (hard disk drive) or a flash memory. In FIG. 1, the disk device 207 is installed outside the computer 201. However, the disk device 207 may be installed within the computer 201.

### <Computer>

The computer 201 includes a CPU (central processing unit) 202 and a main storage 203. Although not illustrated, the computer 201 includes a network interface, an input interface and an output interface.

The CPU 202 reads out a program (not illustrated) stored in the disk device 207 onto the main storage (main memory) 203 and executes the program. Thus the CPU 202 conducts various kinds of operation processing such as XML data registration and retrieval.

The main storage 203 is a storage used when the CPU 202 conducts various kinds of operation processing. The main storage 203 stores unreflected data management information 39, and secures a structure analysis information storage area 40 and an area for a database buffer 44 in a predetermined area. The main storage 203 and the disk device 207 are collectively referred to as storage.

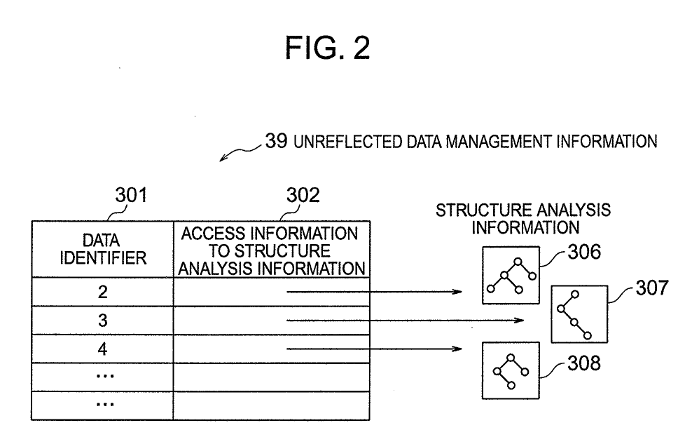

The unreflected data management information 39 is information indicating identifiers of XML data that is included in XML data input to a database management system 10 and that is not yet reflected to the database 60. For example, as exemplified in FIG. 2, a data identifier 301 for XML data and access information 302 (pointer information) for structure analysis information of the XML data are recorded as the unreflected data management information 39.

The database management system 10 can know a data identifier of XML data that is not reflected to any index, by referring to the unreflected data management information 39. Furthermore, the database management system 10 can know a storage area of structure analysis information of the XML data that is not reflected to any index. Furthermore, the database management system 10 can know access information 302 to structure analysis information 306 to 308 generated from these XML data.

The structure analysis information storage area 40 (see FIG. 1) is an area for storing structure analysis information of input XML data. The structure analysis information is information that represents relations among structures represented by tags “< >” in XML data by using a tree structure.

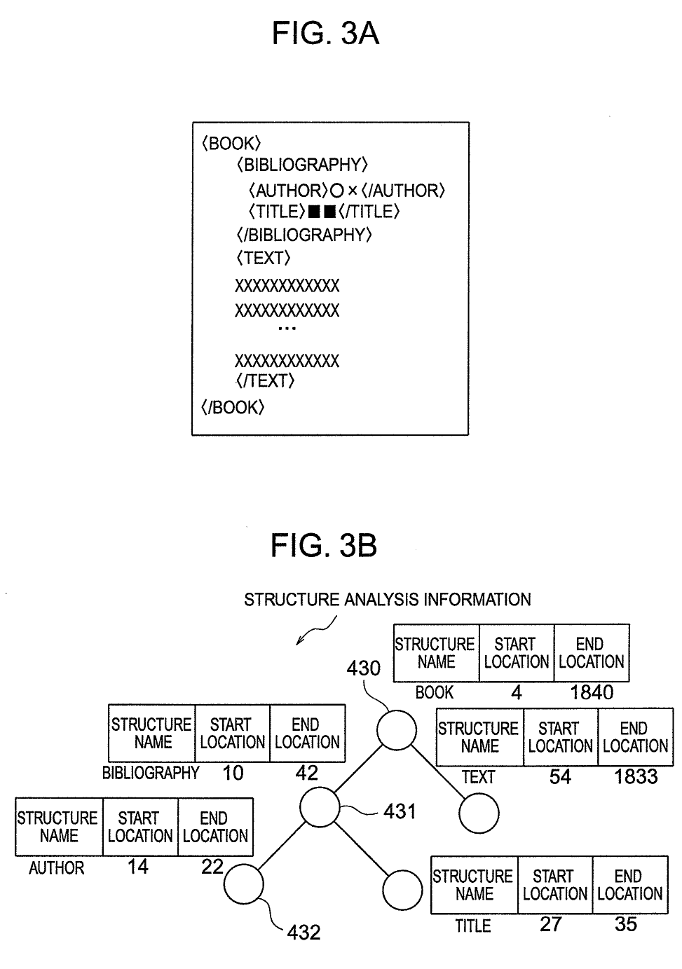

The structure analysis information will now be described with reference to FIGS. 3A and 3B. FIG. 3A is a diagram showing an example of XML data which becomes an object of structure analysis. FIG. 3B is a diagram showing an example of structure analysis information of XML data shown in FIG. 3A.

For example, in the XML data exemplified in FIG. 3A, structure elements <Bibliography> and <Text> are included under a structure element <Book>. Under the structure element <Bibliography>, <Author> and <Title> are included. Structure analysis information exemplified in FIG. 3B is obtained by replacing structure elements in the XML data with nodes and representing the XML data as a tree structure. Relations among structure elements are represented by such a tree structure. By the way, in each node in the structured information, a name of each structure element (Structure name) and location information of the structure element in the XML data are indicated. The location information is information indicating appearance locations of the structure element in the XML data, and the location information is described by a combination of a start location and an end location.

For example, it is indicated in the structure analysis information shown in FIG. 3B that a structure of a structure name “Book” denoted by a numeral 430 has a start location “4” and an end location “1840.” A structure of a structure name “Bibliography” denoted by a numeral 431 is located under the structure name “Book,” and its start location is “10” and its end location is “42.”

Referring back to FIG. 1, such structure analysis information is referred to when an index retrieval processing part 214 (see FIG. 1) retrieves data in the XML data that has become the origin of the structure analysis information. In other words, the index retrieval processing part 214 can know which location in which XML data contains a character string that is an object of retrieval by referring to such structure analysis information. In other words, the index retrieval processing part 214 can narrow down XML data which become the object of the retrieval and a range in the XML data without referring to an index 66.

The database buffer 44 is a storage area used when the database management system 10 reads out XML data from the database 60. In the present embodiment, mainly XML data that are not yet reflected to the index are read out onto the database buffer 44.

FIG. 1 shows a state in which the main storage 203 has the database management system 10 loaded therein as a program. By the way, this program is stored in the disk device 207, loaded into the main storage 203, and executed by the CPU 202.

### <Database Management System>

A configuration of the database management system 10 will now be described. The database management system 10 includes an input processing part 220, an output processing part 230, and a database access control part 210.

The input processing part 220 receives/delivers information input via the network interface, the input interface or the output interface from/to the database access control part 210. The output processing part 230 outputs a result of processing conducted in the database access control part 210 via the network interface, the input interface or the output interface.

The database access control part 210 includes a data management part 216, a structure analysis information management part 217, and an index management part 211.

The database access control part 210 calls the data management part 216, the structure analysis information management part 217, and the index management part 211 according to a kind or condition of an XML data registration request from the terminal device 204 or an XML data retrieval request from the terminal device 205. And the database access control part 210 transmits results of operation processing conducted by the data management part 216, the structure analysis information management part 217, and the index management part 211 to the terminal devices 204 and 205.

The data management part 216 conducts takeout, update and deletion of data in the database 60 stored in the disk device 207.

The structure analysis information management part 217 manages the unreflected data management information 39 and structure analysis information stored in the structure analysis information storage area 40. In other words, the structure analysis information management part 217 adds/deletes structure analysis information to/from the structure analysis information storage area 40. Furthermore, the structure analysis information management part 217 adds/deletes an entry of XML data that is not yet reflected to an index to/from the unreflected data management information 39.

The index management part 211 includes an index registration processing part 212 and the index retrieval processing part 214. The index management part 211 starts these processing parts according to contents of requests from the terminal devices 204 and 205. For example, upon accepting an XML data registration request from the terminal device 204, the index management part 211 starts the index registration processing part 212. Upon accepting an XML data retrieval request from the terminal device 205, the index management part 211 starts the index retrieval processing part 214.

The index registration processing part 212 updates the index 66 in the database 60 on the basis of structure analysis information of XML data.

The index retrieval processing part 214 retrieves the index 66, the structure analysis information and XML data on the database buffer 44 by using an input retrieval condition (a structure condition and a character string condition) as a key.

Details of the database access control part 210 will be described later.

### <Disk Device>

The disk device 207 includes the database 60. The database 60 includes a table 62 for storing XML data, the index 66 of the XML data, and definition information 61.

The table 62 stores XML data. Every data identifier (data ID) of XML data, XML data associated with the identifier is stored in the table 62. TABLE 1 shows an example of the table 62. In TABLE “TI,” XML data associated with data identifiers “1” and “2” are stored.

TABLE 1
TI

| Data identifier | XML data |
|---|---|
| 1 | XML data |
| 2 | XML data |

By the way, XML data that are not yet reflected to the index are also stored in the table 62. The table 62 may contain meta data (for example, registration date of XML data) concerning XML data, besides the XML data.

The index 66 is an index of XML data stored in the table 62. The index 66 is generated every table 62. The index 66 is retrieved by the index retrieval processing part 214.

The index 66 includes a structured index for retrieving, for example, XML data by following structure elements included in the XML data, and a character string index for retrieving a character string of XML data. The structured index is an index which indicates XML data with a tree structure by using a tag of XML data as a node. The character string index is an index which indicates a document number of XML data containing a character string or which indicates a character location in the XML data every character string. The index retrieval processing part 214 can obtain XML data containing a character string indicated in a retrieval condition or a character location of the character string in the XML data, by retrieving the index 66.

The definition information 61 is information that indicates identification information of the index 66 of XML data stored in the table 62 every table 62 in the database 60. The definition information 61 exemplified in TABLE 2 indicates that an index of a table “T1” is “Idx1.” The database access control part 210 can know which index 66 is generated in each table 62 by referring to the definition information 61.

TABLE 2
DEFINITION INFORMATION

| Table | Index |
|---|---|
| T1 | Idx1 |
| . . . | . . . |

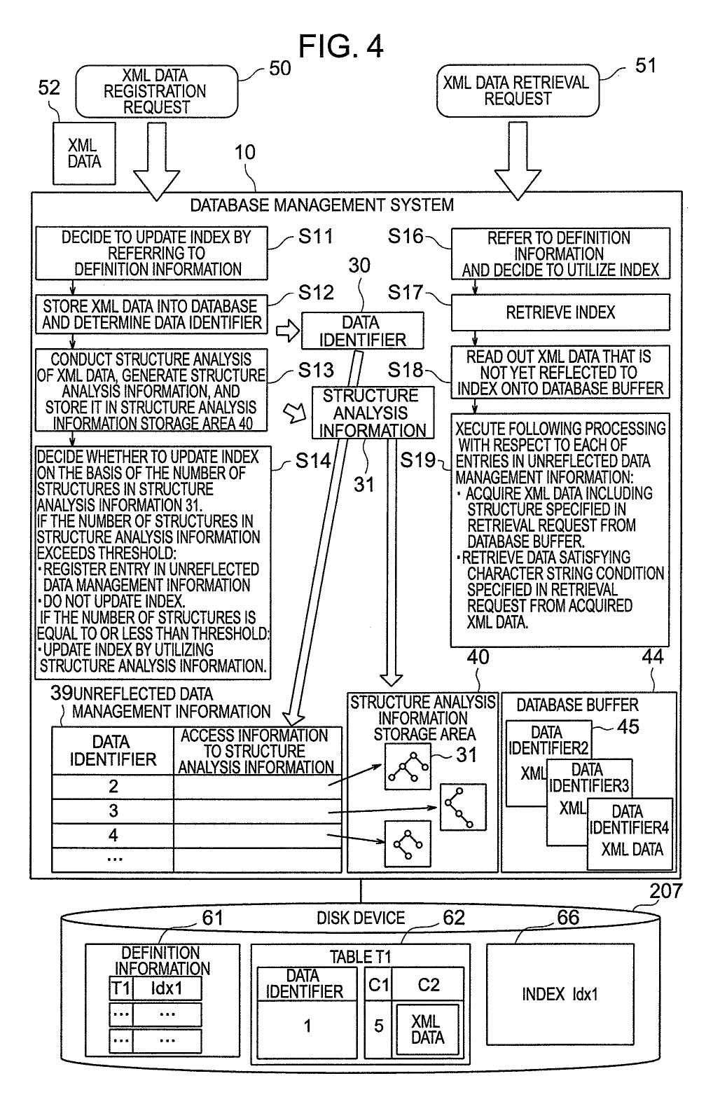

Outline of the system according to the present embodiment will now be described with reference to FIG. 4 together with FIG. 1. FIG. 4 is a diagram for explaining outline of the database management system shown in FIG. 1.

### <Outline of Registration Processing>

First, the input processing part 220 included in the database management system 10 shown in FIG. 1 accepts inputs of XML data 52 and a registration request 50 of the XML data 52 from the application program 221 in the terminal device 204. This registration request includes identification information (for example, “T1”) of the table 62 that is a registration destination of the XML data 52.

The data management part 216 decides to update the index 66 by referring to the definition information 61 in the database 60 (S11). For example, when the table 62 which is the registration destination of the XML data is “T1,” the data management part 216 decides to update the index 66 in the table 62 of “T1” by referring to the definition information 61.

Subsequently, the data management part 216 stores the XML data 52 into the database 60, and determines a data identifier 30 of the XML data 52 (S12). For example, the data management part 216 stores the XML data 52 into the table “T1” in the database 60, and determines a data identifier 30 of the XML data 52.

Subsequently, the index registration processing part 212 conducts structure analysis of the input XML data 52, and generates (creates) structure analysis information. And the index registration processing part 212 stores generated structure analysis information 31 in the structure analysis information storage area 40 (S13).

The index registration processing part 212 decides whether to update the index 66 on the basis of the number of structures in the structure analysis information 31 (S14).

For example, the index registration processing part 212 calculates the number of structures on the basis of the number of tags in the structure analysis information 31 and makes a decision whether the calculated number of structures exceeds a predetermined threshold. In other words, the index registration processing part 212 makes a decision whether the XML data is XML data in which it takes a comparatively long time to update the index.

If the number of structures in the structure analysis information 31 exceeds a predetermined threshold, the structure analysis information management part 217 registers an entry in the unreflected data management information 39. In other words, the structure analysis information management part 217 registers access information to the structure analysis information 31 generated at S13, and the data identifier of the XML data 52 on which the structure analysis information 31 is based, in the unreflected data management information 39. For example, the structure analysis information management part 217 registers the data identifier “2” of the XML data 52 and the access information to the structure analysis information 31. At this time, the index registration processing part 212 does not update the index 66.

On the other hand, if the calculated number of structures is equal to or less than the predetermined threshold, the index registration processing part 212 updates the index 66 by utilizing the structure analysis information. In other words, the index registration processing part 212 updates the index 66 of the table 62 which is the registration destination of the XML data 52 by utilizing the structure analysis information 31 generated at S13.

Thus, with respect to XML data for which the update time of the index 66 is comparatively short, the database management system 10 updates the index 66 on the basis of the structure analysis information of the XML data. On the other hand, with respect to XML data for which the update time of the index 66 is comparatively long, the database management system 10 only generates structure analysis information, but does not update the index 66. The generated structure analysis information is stored in the structure analysis information storage area 40 in the main storage 203 (see FIG. 1).

### <Outline of Retrieval Processing>

Retrieval processing of XML data registered according to the above-described procedure will now be described. The case where the database management system 10 first retrieves the index 66 and then retrieves the unreflected data management information 39 will now be described as an example. However, this is not restrictive. In other words, the database management system 10 may first retrieve the unreflected data management information 39 and then conduct retrieves the index 66.

The input processing part 220 in the database management system 10 accepts input of a retrieval request 51 of XML data. The retrieval request 51 includes a structure condition, a character string condition (and a retrieval condition) of XML data which is the retrieval object.

For example, an input of the retrieval request 51 that specifies “bibliography/author” as the structure condition and “∘×” as the character string condition is accepted. In other words, an input of a retrieval request 51 that a case where a character string “∘×” appears in a structure of “author” located right under a structure “bibliography” in XML data should be retrieved is accepted.

Subsequently, the index retrieval processing part 214 in the index management part 211 refers to the definition information 61 in the database 60 and decides to utilize the index 66 (S16). In other words, the index retrieval processing part 214 refers to the definition information 61 and reads out the index 66 in the database 60.

And the index retrieval processing part 214 retrieves the index 66 (S17), and acquires a document number or a character location of XML data that meets the input retrieval request 51. And the output processing part 230 transmits a result of the retrieval to the application program 222 in the terminal device 205.

Subsequently, the data management part 216 reads out XML data that is not yet reflected to the index onto the database buffer 44 (S18). In other words, the data management part 216 reads out XML data associated with the data identifier that is registered on the unreflected data management information 39 from the table 62 onto the database buffer 44.

The index retrieval processing part 214 executes the following processing with respect to each of entries registered in the unreflected data management information 39 (S19).

XML data including a structure specified in the retrieval request 51 is acquired from the database buffer 44.

Data satisfying the character string condition specified in the retrieval request 51 is retrieved from the acquired XML data.

In other words, the index retrieval processing part 214 first acquires structure analysis information (see FIG. 3B) that contains a structure specified in the retrieval request 51, from structure analysis information stored in the structure analysis information storage area 40. Then, the index retrieval processing part 214 reads out a start location and an end location of the specified structure from the structure analysis information.

For example, when “bibliography/author” is specified as the structure condition in the retrieval request, the index retrieval processing part 214 reads out a start location “14” and an end location “22” of “author” denoted by a numeral 432 located right under “bibliography” denoted by a numeral 431 in structure analysis information exemplified in FIG. 3B.

Subsequently, the index retrieval processing part 214 acquires XML data associated with the structure analysis information from the database buffer 44. And the index retrieval processing part 214 retrieves a character string specified in the retrieval request 51 from data ranging from the start location to the end location in the acquired XML data. And the output processing part 230 transmits a result of the retrieval to the application program 222 in the terminal device 205.

In this way, the index retrieval processing part 214 narrows down the range of the XML data that becomes an object of the retrieval on the basis of the structure analysis information, and then conducts test scan for the character string (character string retrieval). Therefore, the index retrieval processing part 214 can retrieve the XML data before index reflection fast.

### <Details of Registration Processing>

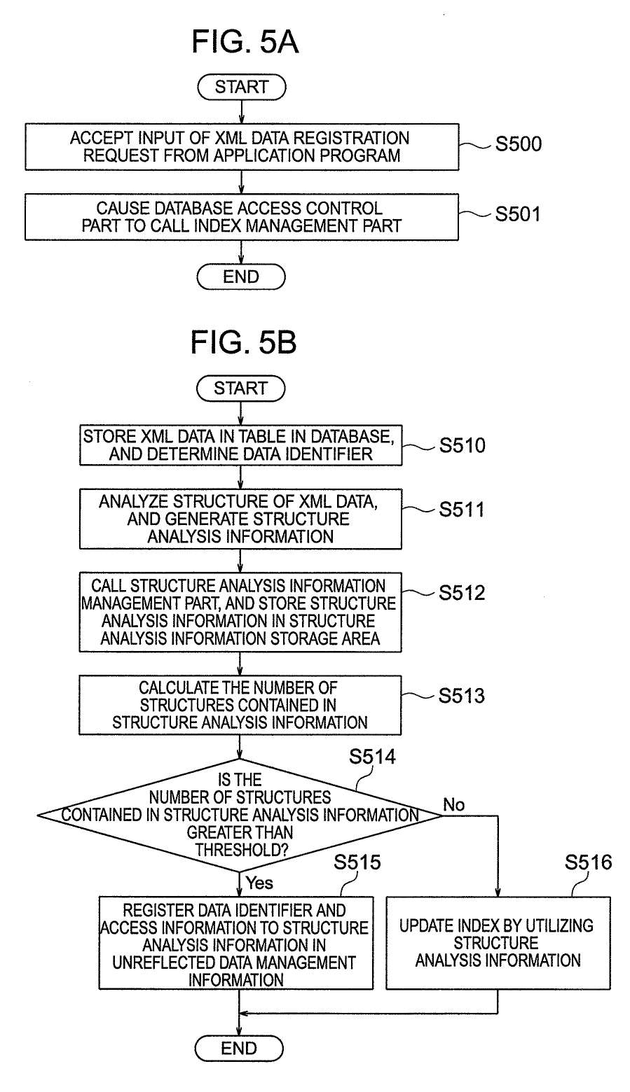

Details of the XML data registration processing will now be described with reference to FIGS. 1, 5A and 5B. FIG. 5A is a flow chart showing an operation procedure of the database management system shown in FIG. 1. FIG. 5B is a flow chart showing an operation procedure of the index registration processing part shown in FIG. 1.

First, the input processing part 220 in the database management system 10 shown in FIG. 1 accepts an input of an XML data registration request from the application program 221 in the terminal device 204 (S500), and the database access control part 210 calls the index management part 211 (S501). As described earlier, the XML data registration request contains XML data that becomes the object of the registration, and identification information of the table 62 that is the storage destination (registration destination) of the XML data.

Subsequently, the index management part 211 calls the index registration processing part 212. And the index registration processing part 212 stores the XML data in the table 62 in the database 60 specified at S501, and determines a data identifier of the XML data (S510).

Subsequently, the index registration processing part 212 analyzes a structure of XML data that is the object of the registration request, and generates structure analysis information (see FIG. 3B) (S511).

The index management part 211 calls the structure analysis information management part 217. The structure analysis information management part 217 stores the structure analysis information generated at S511 in the structure analysis information storage area 40 (S512).

Subsequently, the index registration processing part 212 calculates the number of structures contained in the structure analysis information generated at S511 (S513), and makes a decision whether the number of structures thus calculated is greater than a threshold (S514).

When the number of structures contained in the structure analysis information is greater than the threshold (yes at S514), the structure analysis information management part 217 registers the data identifier of the XML data on which the structure analysis information is based and access information to the structure analysis information in the unreflected data management information 39 (S515). Here, the index registration processing part 212 does not update the index 66.

On the other hand, when the number of structures contained in the structure analysis information is equal to or less than the threshold (no at S514), the index registration processing part 212 updates the index 66 by utilizing the structure analysis information (S516). In other words, the index registration processing part 212 reflects the structure analysis information to the index 66. Thereafter, the structure analysis information management part 217 deletes the entry of the structure analysis information that has already been reflected to the index, from the unreflected data management information 39. Furthermore, it is desirable that the structure analysis information management part 217 deletes the structure analysis information that has already been reflected to the index, from the structure analysis information storage area 40. By doing so, the storage area of the main storage 203 can be utilized effectively.

In this way, the index registration processing part 212 registers the XML data in the database 60. With respect to XML data for which the number of structures is small and it is presumed that a long time is not taken to update the index, the index registration processing part 212 conducts index update based upon XML data. On the other hand, with respect to XML data for which the number of structures is large and it is presumed that a long time is taken to update the index, the index registration processing part 212 retains the structure analysis information intact in the main storage 203 (processing heretofore described is referred to as fast registration processing).

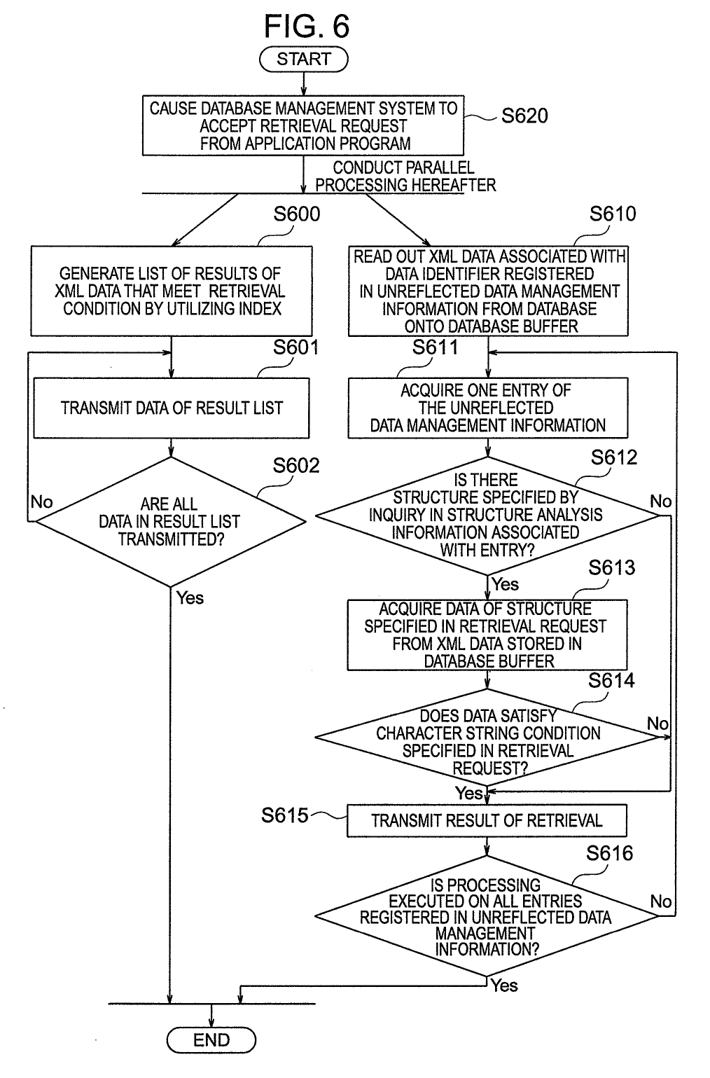

Upon accepting an XML data retrieval request, the database management system 10 retrieves the index 66, with respect to XML data that is not yet reflected to the index. On the other hand, with respect to XML data that is not yet reflected to the index, retrieval is conducted by using structure analysis information in the structure analysis information storage area 40 and the XML data read out onto the database buffer 44. By doing so, the database management system 10 can retrieve the XML data fast without increasing the registration time of structured data. Details of the retrieval processing at this time will be described later with reference to FIG. 6.

The index registration processing part 212 decides whether to conduct index update on the basis of the number of structures in the structure analysis information. However, this is not restrictive. For example, the index registration processing part 212 may decide whether to conduct index update on the basis of the number of structures and the data size of XML data on which the structure analysis information is based. The index registration processing part 212 may expect the time (registration processing time) taken to reflect the index of the XML data to the index 66 on the basis of the data size and the number of structures of the XML data and decide whether to conduct the index update on the basis of the registration processing time. In this case, the threshold used at S514 in FIG. 5B is set to an upper limit value of registration processing time (registration upper limit time).

### <Details of Retrieval Processing>

Retrieval processing of XML data will now be described with reference to FIGS. 1 and 6. FIG. 6 is a flow chart showing an operation procedure of the database management system shown in FIG. 1.

First, the database management system 10 shown in FIG. 1 accepts an input of an XML data retrieval request from the application program 222 in the terminal device 205 by using the input processing part 220 (S620). And the database management system 10 conducts processing (index retrieval processing) ranging from S600 to S602 and processing (index-unreflected data retrieval processing) ranging from S610 to S616 in parallel.

First, processing (index retrieval processing) ranging from S600 to S602 will now be described.

The database access control part 210 calls the index management part 211, and the index management part 211 calls the index retrieval processing part 214. The index retrieval processing part 214 generates a list of results of XML data that meet the retrieval condition indicated in the retrieval request by utilizing the index 66 (S600). For example, the index retrieval processing part 214 retrieves the index 66 and generates a list of XML data satisfying the structure condition and character string condition indicated in the retrieval condition or information such as the document number and character location of the XML data.

Subsequently, the index retrieval processing part 214 transmits data of the result list of the XML data to the application program 222 in the terminal device 205 which is the transmission source of the retrieval request, via the output processing part 230 (S601).

Upon transmitting all data of the result list generated at S600 to the application program 222 in the terminal device 205 (yes at S602), the index retrieval processing part 214 terminates the processing. On the other hand, if transmission of all data of the result list to the application program 222 in the terminal device 205 has not been completed, then the index retrieval processing part 214 returns to S601.

The processing ranging from S610 to S616 (index-unreflected data retrieval processing) will now be described.

In the same way as the above-described index retrieval processing, the database access control part 210 calls the index management part 211, and the index management part 211 calls the index retrieval processing part 214. And the data management part 216 reads out XML data associated with the data identifier registered in the unreflected data management information 39 from the database 60 onto the database buffer 44 (S610).

Subsequently, the index retrieval processing part 214 acquires one entry of the unreflected data management information 39 (S611). And the index retrieval processing part 214 refers to access information to structure analysis information (see numeral 302 in FIG. 2) and acquires structure analysis information from the structure analysis information storage area 40.

The index retrieval processing part 214 makes a decision whether there is a structure specified by an inquiry (a structure specified in the retrieval request) in structure analysis information associated with this entry (structure analysis information that is the processing object) (S612). For example, when “bibliography/author” is specified, as the structure condition in the retrieval request, the index retrieval processing part 214 makes a decision whether there is this structure in the structure analysis information.

If the structure specified in the retrieval request exists in structure analysis information to be processed (yes at S612), the index retrieval processing part 214 refers to this structure analysis information and acquires data of the structure specified in the retrieval request from the XML data stored in the database buffer 44 (S613). On the other hand, if the structure specified in the retrieval request does not exist in the structure analysis information (no at S612), the index retrieval processing part 214 proceeds to S616.

This will be described with reference to the example shown in FIGS. 3A and 3B. Upon finding structure analysis information containing the structure “bibliography/author” from the structure analysis information storage area 40, the index retrieval processing part 214 acquires the data identifier of the XML data on which the structure analysis information is based and location information (the start location and the end location) of the structure “bibliography/author” in the XML data. As for the data identifier of the XML data, the index retrieval processing part 214 acquires it by referring to the unreflected data management information 39. And the index retrieval processing part 214 acquires data satisfying the structure condition specified in the retrieval request, from the XML data stored in the database buffer 44, on the basis of the data identifier of the XML data and the location information of the structure. For example, the index retrieval processing part 214 takes out data ranging from the start location to the end location of the structure indicated in the structure analysis information, from the XML data. Details of S616 will be described later.

And the index retrieval processing part 214 makes a decision whether data acquired at S613 satisfies the character string condition specified in the retrieval request (S614). For example, the index retrieval processing part 214 retrieves a character string specified in the retrieval request from data acquired at S613 and makes a decision whether the character string exists in the data acquired at S613.

If the data acquired at S613 satisfies the character string condition specified in the retrieval request (yes at S614), then the index retrieval processing part 214 transmits a result of the retrieval to the application program 222 in the terminal device 205 via the output processing part 230 (S615). On the other hand, if the data acquired at S613 does not satisfy the character string condition specified in the retrieval request (no at S6149, then the index retrieval processing part 214 proceeds to S616.

The index retrieval processing part 214 makes a decision whether the processing ranging from S611 to S615 has been executed on all entries registered in the unreflected data management information 39 (S616). If there is an entry for which the processing ranging from S611 to S615 has not yet been executed (no at S616), then the index retrieval processing part 214 returns to S611. If the processing ranging from S611 to S615 has been executed on all entries registered in the unreflected data management information 39 (yes at S616), the index-unreflected data retrieval processing is terminated.

If both the processing ranging from S600 to S602 (the index retrieval processing) and the processing ranging from S610 to S616 (the index-unreflected data retrieval processing) have been terminated, then the index management part 211 terminates the processing conducted by the index retrieval processing part 214.

In this way, the database management system 10 retrieves data satisfying the structure condition and the character string condition indicated in the retrieval request from XML data stored in the database 60.

In the foregoing description, the database management system 10 conducts the index retrieval processing and the index-unreflected data retrieval processing in parallel. However, this is not restrictive. For example, the database management system 10 may first conduct the index-unreflected data retrieval processing and then conduct the index retrieval processing, or vice versa.

### Second Embodiment

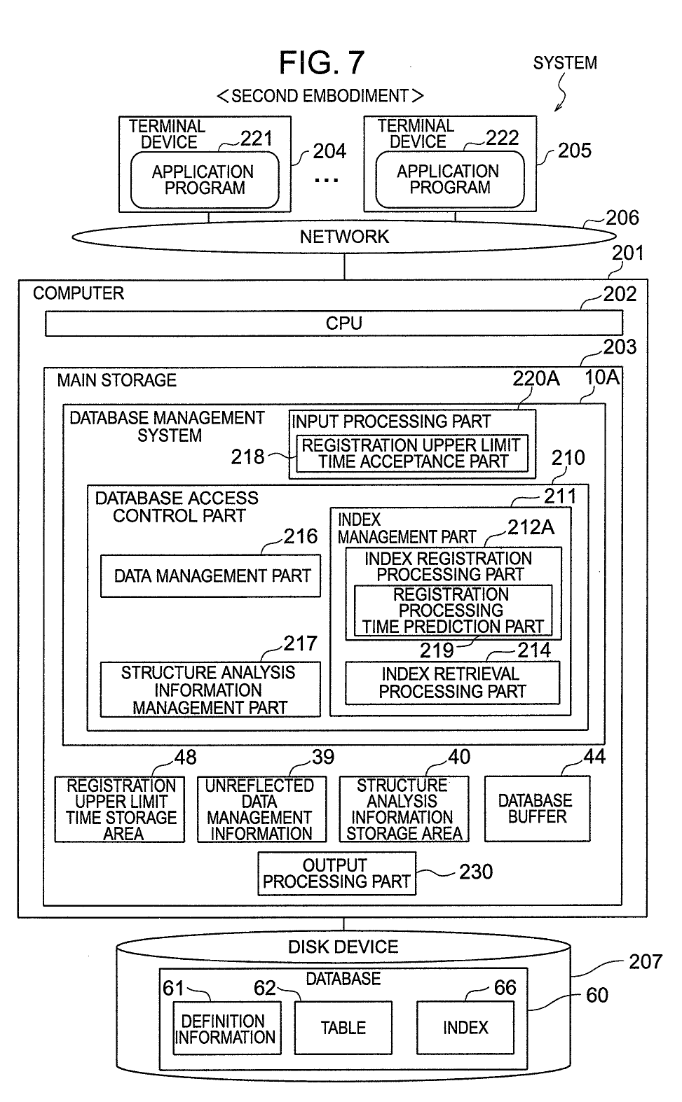

A second embodiment of the present invention will now be described. FIG. 7 is a diagram showing a configuration example of a system including a database management system according to the second embodiment. The same components as those in the first embodiment are denoted by like characters, and description of them will be omitted.

A database management system 10A according to the second embodiment has a feature that it decides whether to conduct index update of the XML data on the basis of a registration upper limit value transmitted from the application program 221. The registration upper limit value is an upper limit value of time required to reflect the XML data to the index 66, i.e., an upper limit value of registration processing time.

As shown in FIG. 7, the database management system 10A includes a registration upper limit time storage area 48. Furthermore, an input processing part 220A includes a registration upper limit time acceptance part 218. In addition, an index registration processing part 212A includes a registration processing time prediction part 219.

The registration upper limit time storage area 48 is an area for storing the registration upper limit time transmitted from the application program 221.

The registration upper limit time acceptance part 218 accepts input of the registration upper limit time transmitted from the application program 221. The registration upper limit time acceptance part 218 stores the registration upper limit time thus accepted in the registration upper limit time storage area 48.

The registration processing time prediction part 219 predicts time (registration processing time) required to reflect the XML data transmitted from the application program 221 to the index 66, on the basis of the XML data. By the way, the registration processing time in the present embodiment refers to time taken since the database management system 10 accepts input of the XML data until index update based on the XML data is terminated.

Furthermore, the index registration processing part 212A compares the predicted registration processing time with the registration upper limit time stored in the registration upper limit time storage area 48. If the predicted registration processing time does not exceed the registration upper limit time, the index registration processing part 212A reflects the XML data to the index 66. In other words, the index registration processing part 212A reflects XML data that can be reflected to the index 66 in a comparatively short time, to the index 66 immediately.

On the other hand, if the predicted registration processing time exceeds the registration upper limit time, the index registration processing part 212A does not reflect the index of the XML data to the index 66. And the structure analysis information management part 217 stores the structure analysis information of the XML data in the structure analysis information storage area 40, and registers information concerning the structure analysis information in the unreflected data management information 39.

### <Details of Registration Processing>

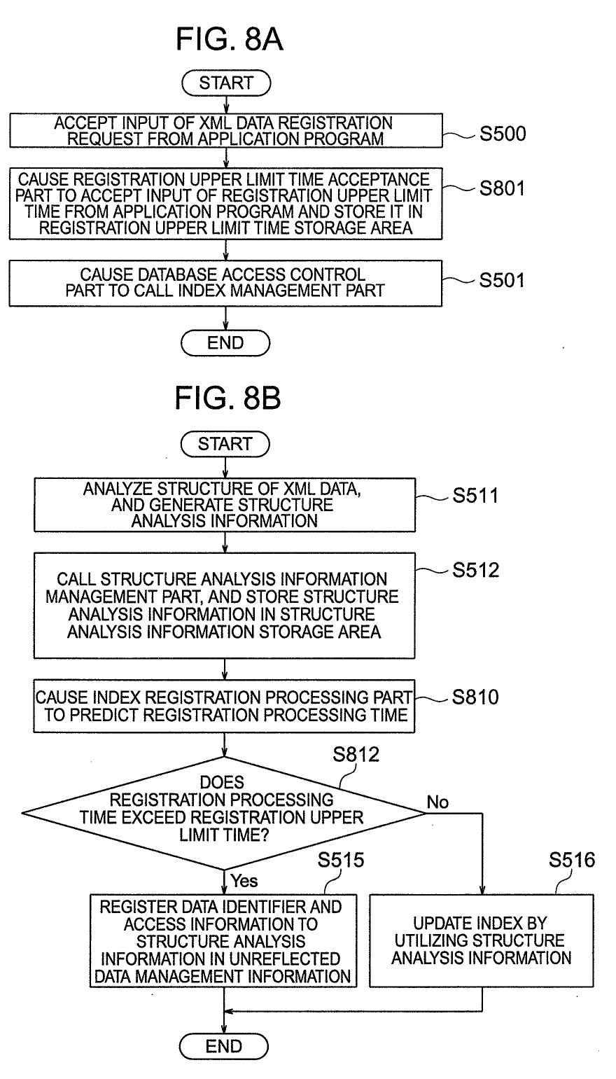

XML data registration processing according to the second embodiment will now be described with reference to FIGS. 7, 8A and 8B.

FIG. 8A is a flow chart showing an operation procedure of the database management system shown in FIG. 7. FIG. 8B is a flow chart showing an operation procedure of the index registration processing part shown in FIG. 7.

First, the input processing part 220A in the database management system 10A shown in FIG. 7 accepts an input of an XML data registration request from the application program 221 in the terminal device 204 (S500).

Furthermore, the input processing part 220A accepts input of the registration upper limit time from the application program 221 by using the registration upper limit time acceptance part 218, and stores the registration upper limit time in the registration upper limit time storage area 48 (S801). By the way, the XML data registration request at S500 and the registration upper limit time at S801 may be input simultaneously, or it is also possible to conduct S801 in advance and then conduct S500.

In the same way as S501 in FIG. 5A, the database access control part 210 calls the index management part 211 (S501).

Since S511 and S512 in FIG. 8B are the same as S511 and S512 in FIG. 5B, description of them will be omitted. S810 in FIG. 8B will now be described.

The registration processing time prediction part 219 predicts the registration processing time of the index of the XML data (S810). Prediction of the registration processing time at this time is conducted on the basis of the number of structures of XML data (for example, the number of tags) and the data size.

Thereafter, the index registration processing part 212A makes a decision whether the registration processing time predicted at S810 exceeds the registration upper limit time (S812). If the registration processing time predicted at S810 exceeds the registration upper limit time (yes at S812), the index registration processing part 212A proceeds to S515. On the other hand, if the predicted registration processing time is equal to or less than the registration upper limit time (no at S812), the index registration processing part 212A proceeds to S516. Since S515 and S516 in FIG. 8B are the same as S515 and S516 in FIG. 5B, description of them will be omitted. By the way, after the index registration processing part 212A updates the index 66 at S516, the structure analysis information management part 217 deletes an entry of structure analysis information already reflected to the index from the unreflected data management information 39. Furthermore, the structure analysis information management part 217 deletes structure analysis information already reflected to the index from the structure analysis information storage area 40 as well.

According to the database management system 10A, the threshold used in the decision whether to update the index of the XML data can be set to an arbitrary value. Therefore, the database management system 10A can change the threshold according to various system requirements, resulting in great convenience.

The database management system 10A accepts input of the registration upper limit time from the application program 221. Alternatively, the database management system 10A may accept input of upper limit values of the number of structures and the data size of XML data. In other words, at S812 in FIG. 8B, the index registration processing part 212A may decide whether to update the index by comparing the number of structures (the number of structures in the structure analysis information) or data size of the XML data with the threshold in the same way as S514 in FIG. 5B. In this case, the index registration processing part 212A need not include the registration processing time prediction part 219. By the way, the registration processing time, the data size of the XML data, and the number of structures included in the structured data are collectively referred to as processing cost of the XML data.

### Third Embodiment

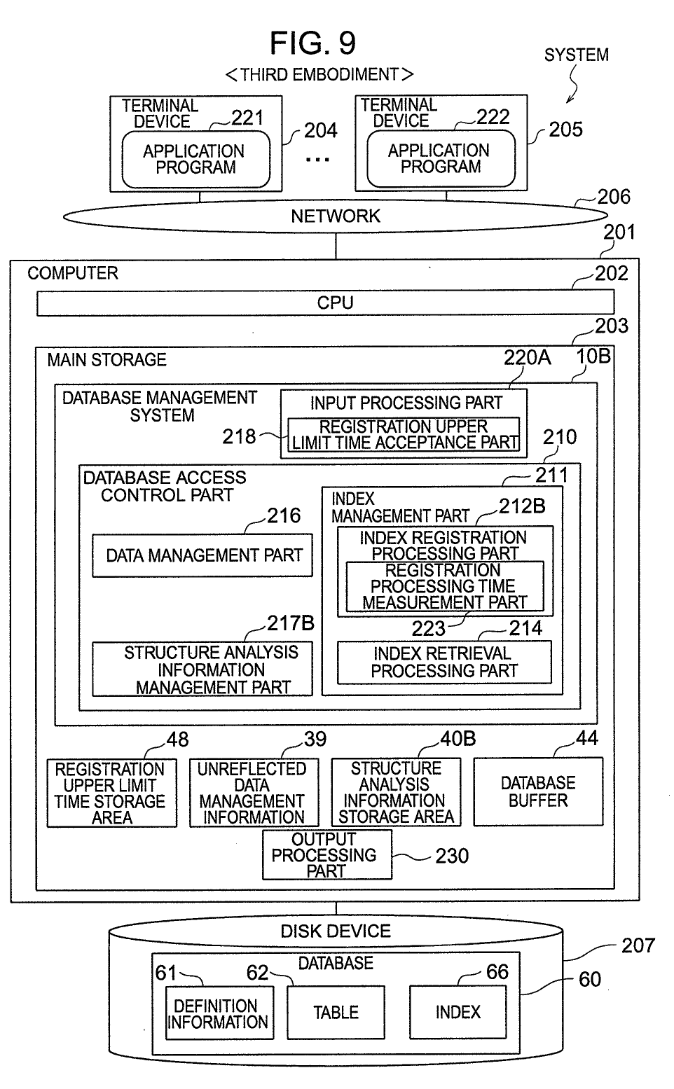

A third embodiment of the present invention will now be described with reference to FIG. 9. FIG. 9 is a diagram showing a configuration example of a system including a database management system according to the third embodiment. The same components as those in the above-described embodiments are denoted by like characters, and description of them will be omitted.

A database management system 10B according to the third embodiment has a feature that even data for which the registration processing time of XML data exceeds the registration upper limit time is reflected to the index 66 halfway. In other words, the database management system 10B has a feature that index update is conducted on XML data in which the data size or the number of structures is comparatively great and the registration processing time exceeds the registration upper limit time, as much as possible within the registration upper limit time.

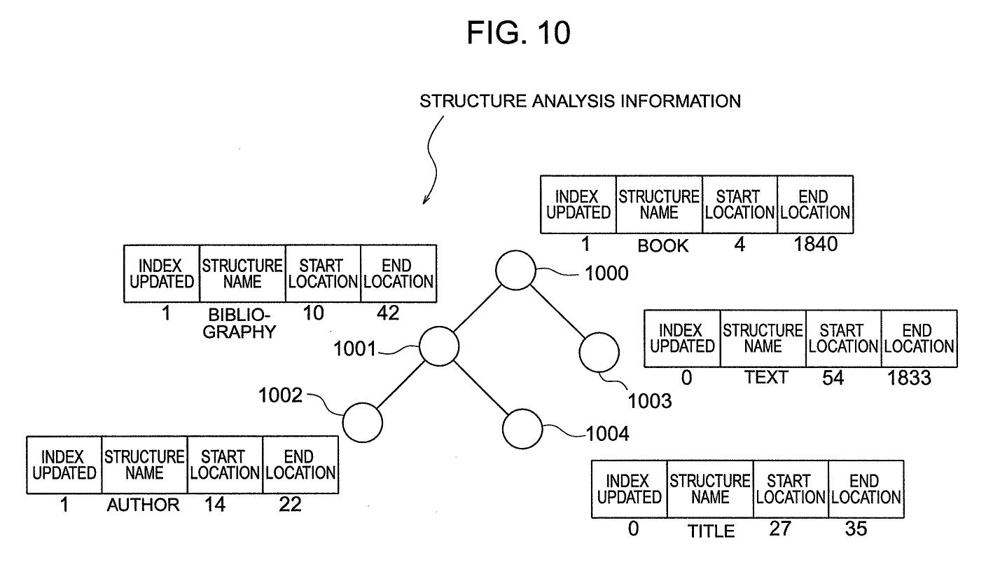

Structure analysis information processed by the database management system 10B will now be described with reference to FIG. 10. FIG. 10 is a diagram showing an example of structure analysis information processed by the database management system shown in FIG. 9.

As shown in FIG. 10, each node in the structure analysis information contains a value of an index update completion flag, besides an element name (structure name) of each structure element, and location information of the structure element in XML data. The index update completion flag is a value that indicates whether this structure is already reflected to the index 66. As to a node that is already reflected to the index 66, “1” is set in an index update completion flag column. On the other hand, as to a node that is not yet reflected to the index 66, “0” is set in an index update completion flag column.

In other words, it is indicated in FIG. 10 that a structure element having a structure name “book” denoted by a numeral 1000, a structure element having a structure name “bibliography” denoted by a numeral 1001, and a structure element having a structure name “author” denoted by a numeral 1002 are reflected to the index 66. On the other hand, it is indicated that a structure element having a structure name “text” denoted by a numeral 1003 and a structure element having a structure name “title” denoted by a numeral 1004 are not yet reflected to the index 66.

In this way, the database management system 10B reflects structure analysis information to the index 66 even partially.

Referring back to FIG. 9, an index registration processing part 212B includes a registration processing time measurement part 223 instead of the above-described registration processing time prediction part 219. Furthermore, a structure analysis information management part 217B sets the index update completion flag for structure elements subjected to the index-reflection and included in structure elements of the structure analysis information.

The registration processing time measurement part 223 measures time (registration processing time) elapsed since the database management system 10B accepts the input of the XML data to be registered. The index registration processing part 212B updates the index 66 on the basis of structure analysis information generated by using the XML, in a range in which the registration processing time measured by the registration processing time measurement part 223 is within the registration upper limit time. In other words, the index registration processing part 212B starts reflection of the structure analysis information to the index 66, and stops the reflection of the structure analysis information to the index 66 when the registration upper limit time has elapsed.

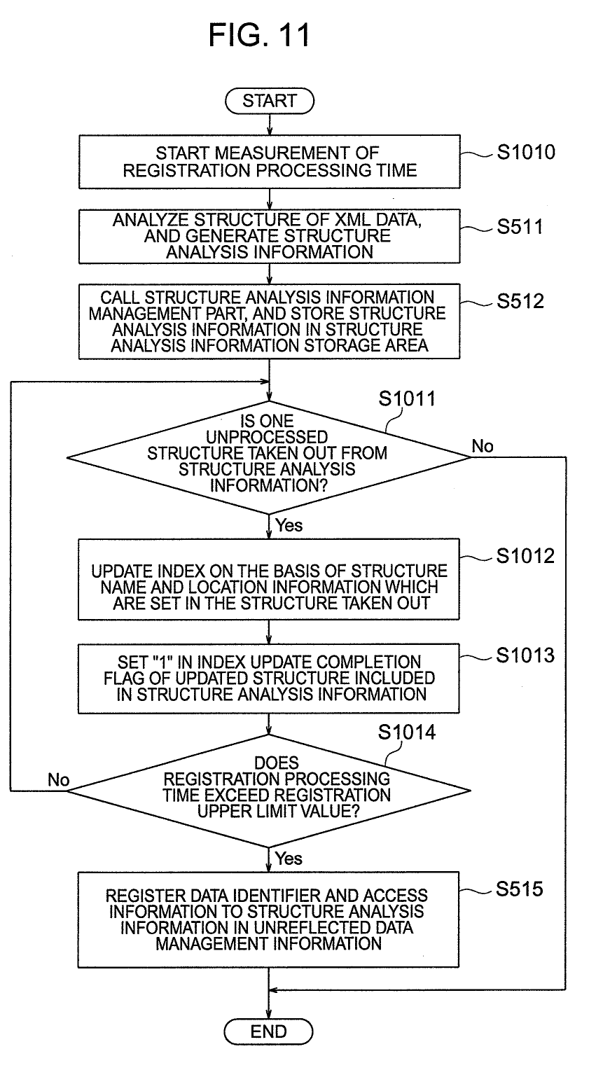

XML data registration processing in the third embodiment will now be described with reference to FIGS. 9 and 11. FIG. 11 is a flow chart showing an operation procedure of the index registration processing part shown in FIG. 9.

Processing conducted since an input of an XML data registration request is accepted from the application program 221 in the terminal device 204 until the database access control part 210 calls the index management part 211 is the same as the processing procedure shown in FIG. 8A. Therefore, description of the processing will be omitted, and description will be started from S1010 in FIG. 11.

If the database access control part 210 is called, the index registration processing part 212B starts the registration processing time measurement part 223 and starts measurement of the registration processing time (S1010). Since subsequent S511 and S512 are the same as S511 and S512 in FIG. 5B and FIG. 8B, description of them will be omitted.

After S512, the index registration processing part 212B reads out structure analysis information of the XML data to be registered, from a structure analysis information storage area 40B. If one unprocessed structure is taken out from structures (structure elements) of the structure analysis information (yes at S1011), the index registration processing part 212B updates the index 66 on the basis of a structure name and location information which are set in the structure thus taken out (S1012). In other words, the index registration processing part 212B reflects information which is set in this structure to the index 66.

And the structure analysis information management part 217B sets “1” in the index update completion flag of a structure included in structure analysis information and subjected to update of the index 66 at S1012 (S1013).

For example, the index registration processing part 212B reflects information of the structure name “book,” a start location “4” and an end location “1840” included in structure analysis information exemplified in FIG. 10 and preset in a node denoted by a numeral 1000. Furthermore, the structure analysis information management part 217B sets “1” in the index update completion flag in this node.

The index registration processing part 212B makes a decision whether registration processing time measured by the registration processing time measurement part 223 exceeds registration upper limit value (S1014). If the measured registration processing time does not yet exceed the registration upper limit time (no at S1014), the index registration processing part 212B returns to S1011. In other words, the index registration processing part 212B checks whether the registration upper limit time is exceeded each time one structure element in the structure analysis information is reflected to the index 66.

On the other hand, if the registration processing time exceeds the registration upper limit time (yes at S1014), the structure analysis information management part 217B registers the data identifier of the XML data on which the structure analysis information is based and access information to the structure analysis information in the unreflected data management information 39 in the same way as S515 in FIG. 5B (S515). In other words, the structure analysis information management part 217B registers an entry into the unreflected data management information 39, with respect to structure analysis information that is not yet completed in index reflection with respect to all structures. And the registration is terminated.

If an unprocessed structure cannot be taken out from the structure analysis information (no at S1011), i.e., processing on all structures of the structure analysis information has been finished within the registration upper limit value, then the index registration processing part 212B terminates the processing as it is.

By doing so, the database management system 10B can conduct the index update processing within the registration upper limit time even if prediction of the registration processing time of the XML data is difficult. Furthermore, the database management system 10B conducts index update partially even with respect to XML data that is comparatively large in data size or the number of structures. In other words, it is prevented that the index of the XML data that is comparatively large in data size and the number of structures is not registered at all. Therefore, more information is registered in the index 66. As a result, the database management system 10B can conduct retrieval of XML data fast.

In the third embodiment, measurement of the registration processing time is started at the input timing of XML data. However, this is not restrictive. For example, the measurement may be started when the structure of structure analysis information is begun to be reflected after the structure analysis information of the XML data is generated.

In the systems according to the first to third embodiments, XML data that exceeds a predetermined threshold in the number of structures or registration processing time is not reflected to the index 66, but remains in the database 60. The database management system 10 may reflect such XML data to the index 66 at timing different from when accepting the registration request of the XML data (for example, when accepting an order input separately). A processing procedure of the database management system in this case will now be described as fourth to sixth embodiments.

### Fourth Embodiment

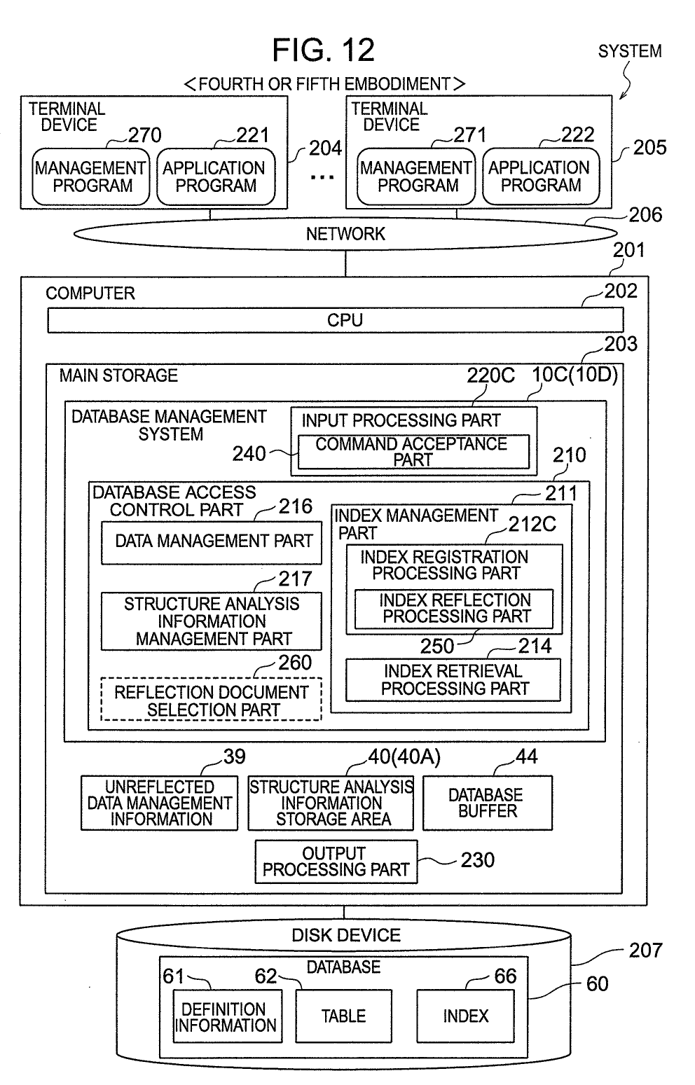

A fourth embodiment of the present invention will now be described. FIG. 12 is a diagram showing a configuration example of a system including a database management system according to the fourth embodiment or a fifth embodiment. The same components as those in the above-described embodiments are denoted by like characters, and description of them will be omitted. The fifth embodiment will be described later.

A database management system 10C according to the fourth embodiment has the following feature. Upon accepting a command input from a management program 270 in the terminal device 204 or a management program 271 in the terminal device 205, the database management system 10C reflects index-unreflected XML data stored in the database 60 to the index 66 by taking the command input acceptance as a trigger.

As shown in FIG. 12, the terminal devices 204 and 205 include the management programs 270 and 271, respectively. Each of the management programs 270 and 271 is a program that accepts an order input of reflection of XML data to the index 66 via an input device connected to the terminal device 204 or 205 and transmits the order input to the computer 201.

An input processing part 220C in the database management system 10C includes a command acceptance part 240 which accepts the command input transmitted from the management program 270 or 271.

An index registration processing part 212C includes an index reflection processing part 250 which reflects index-unreflected structure analysis information to the index 66 on the basis of the order input output by the command acceptance part 240. A reflection document selection part 260 surrounded by a dotted line will be described later with reference to the fifth embodiment.

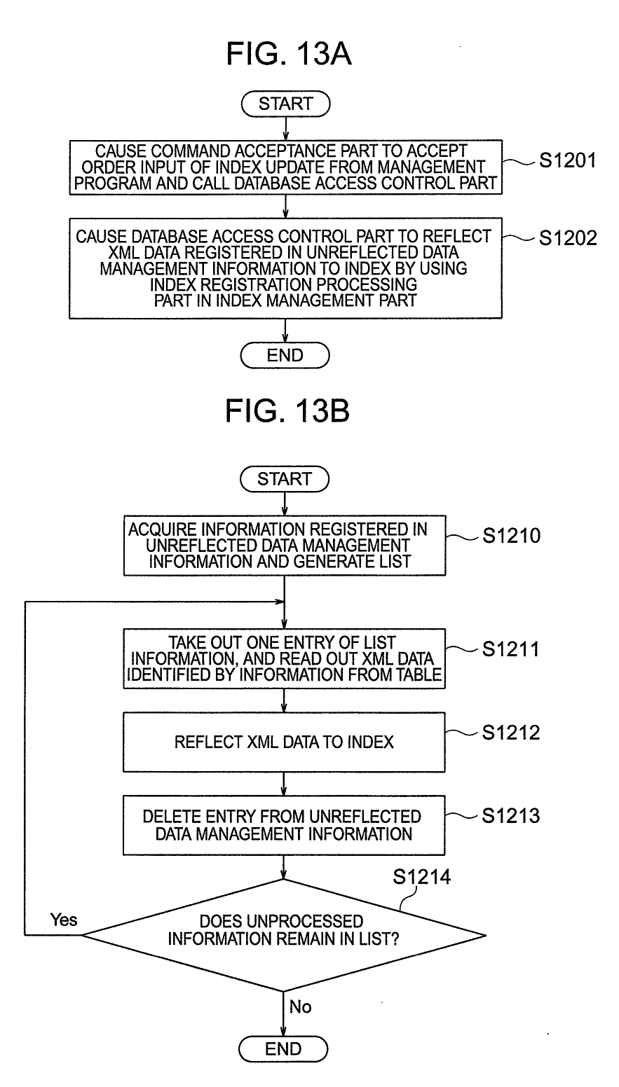

Details of the XML data registration processing in the fourth embodiment will now be described with reference to FIGS. 12, 13A and 13B. FIG. 13A is a flow chart showing an operation procedure of the database management system shown in FIG. 12. FIG. 13B is a flow chart showing an operation procedure of the index registration processing part shown in FIG. 1. The case where the database management system 10C has accepted an order input of index update from the management program in the terminal device 204 will now be described as an example.

The command acceptance part 240 in the database management system 10C shown in FIG. 12 accepts the order input of index update from the management program 270, and calls the database access control part 210 (S1201).

The database access control part 210 reflects XML data registered in the unreflected data management information 39 (index-unreflected XML data) to the index 66 by using the index registration processing part 212C in the index management part 211 (S1202). In other words, the database access control part 210 reflects XML data associated with data identifiers that are registered in the unreflected data management information 39 to the index 66.

Processing of reflection to the index 66 conducted at this time will now be described in detail with reference to FIG. 13B.

First, the index reflection processing part 250 shown in FIG. 12 acquires information registered in the unreflected data management information 39 and generates a list (S1210). The generated list is stored in the main storage 203. The list generated at this time is, for example, information indicating data identifiers of XML data to be subject to index update.

Subsequently, the index reflection processing part 250 takes out one entry of list information. And the index reflection processing part 250 requests the data management part 216 to read out XML data associated with a data identifier indicated in this information. The data management part 216 reads out the XML data from the table 62 (S1211).

The index registration processing part 212C reflects the XML data thus read out to the index 66 (S1212).

Thereafter, the structure analysis information management part 217 deletes the entry of structure analysis information concerning XML data already reflected to the index, from the unreflected data management information 39 (S1213). Furthermore, the structure analysis information management part 217 deletes structure analysis information concerning XML data already reflected to the index, from the structure analysis information storage area 40 as well.

The index reflection processing part 250 makes a decision whether unprocessed information still remains in the list (S1214). If unprocessed information still remains (yes at S1214), the index reflection processing part 250 returns to S1211. On the other hand, if unprocessed information does not remain (no at S1214), the processing is terminated.

By doing so, the database management system 10C can reflect index-unreflected XML data to the index 66.

In the above-described embodiments, the database management system 10C reflects all index-unreflected XML data to the index 66. However, this is not restrictive. For example, the database management system 10C may select predetermined XML data from among index-unreflected XML data and reflect the predetermined XML data to the index 66. The embodiment at this time will be described as a fifth embodiment.

### Fifth Embodiment

In succession, a fifth embodiment of the present invention will be described with reference to FIG. 12. Components that are the same as those in the above-described embodiments are denoted by like characters, and description of them will be omitted.

A database management system 10D according to the fifth embodiment has a feature that it accepts a selection input of XML data to be subject to index reflection from the management program 270 or 271.

As shown in FIG. 12, the database management system 10D has a feature that it includes a reflection document selection part 260.

The reflection document selection part 260 accepts a selection input of XML data to be subject to index reflection from the management program 270 or 271. The index reflection processing part 250 recognizes XML data which is contained in a list of index-unreflected XML data and for which selection input is accepted by the reflection document selection part 260 as the object of index reflection. In other words, the index reflection processing part 250 lists all index-unreflected XML data. However, the index reflection processing part 250 deletes XML data that have not been selected by the management programs 270 and 271 respectively in the terminal devices 204 and 205 from the list as non-objects of the index reflection.

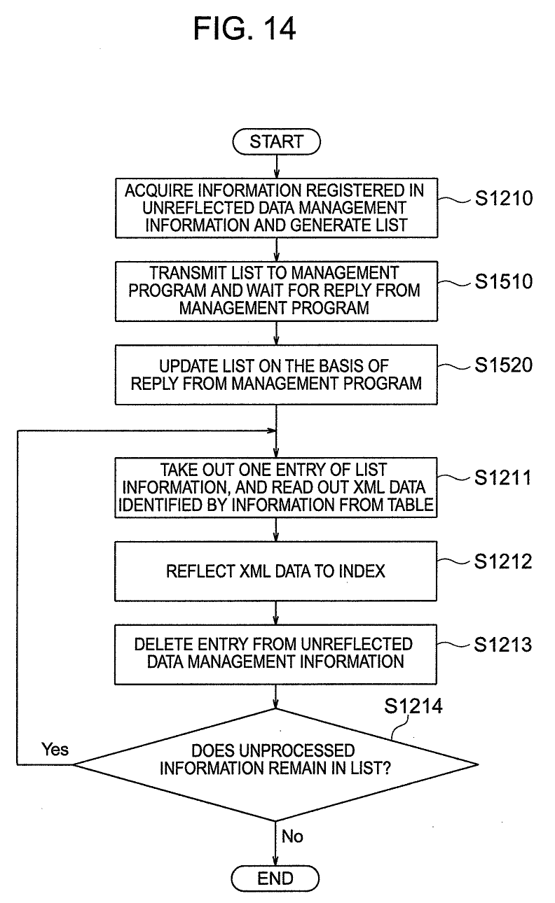

Registration processing of XML data in the fifth embodiment will now be described with reference to FIGS. 12 and 14. FIG. 14 is a flow chart showing an operation procedure of the database access control part shown in FIG. 12.

The procedure followed since the command acceptance part 240 shown in FIG. 12 accepts an order input of index update from the management program 270 until the index reflection processing part 250 generates the list is the same as that in the fourth embodiment. Therefore, description will be started from S1510 in FIG. 14.

First, the reflection document selection part 260 transmits a list generated by the index reflection processing part 250 at S1210 to the management program 270 in the terminal device 204, and waits for a reply from the management program 270 (S1510).

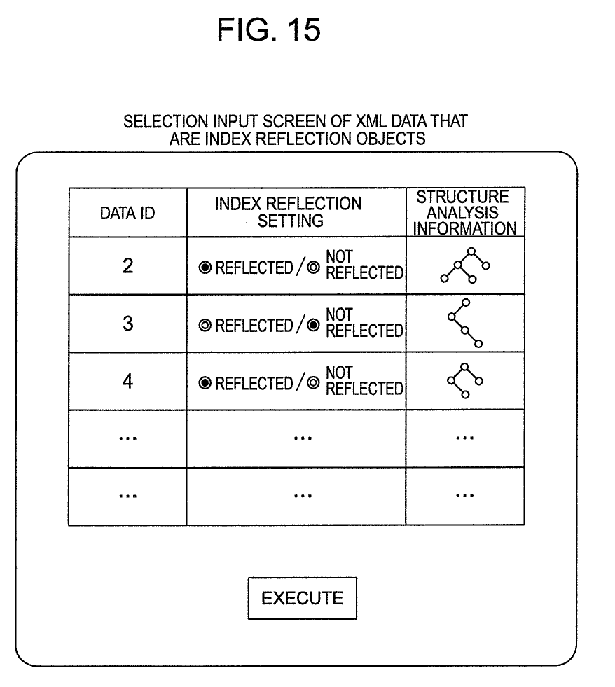

Upon receiving the list transmitted by the reflection document selection part 260, the management program 270 causes an output device (not illustrated) in the terminal device 204 to display a selection input screen of XML data to be subject to index reflection. A screen example at this time will be described later with reference to FIG. 15.

Upon receiving a reply from the management program 270 in the terminal device 204, the reflection document selection part 260 outputs the reply to the index reflection processing part 250. The index reflection processing part 250 updates the list generated at S1210 on the basis of the reply thus output (S1520). In other words, upon receiving selection information of XML data to be subject to index reflection from the reflection document selection part 260, the index reflection processing part 250 leaves XML data indicated by the selection information in the list, and deletes other XML data from the list.

Since subsequent processing ranging from S1211 to S1214 is the same as the processing ranging from S1211 to S1214 shown in FIG. 13B, description thereof will be omitted.

By doing so, the database management system 10D can designate XML data selected by the terminal device 204 as the object of index reflection. For example, in the case where there are a large number of index-unreflected XML data in the database 60, a system manager or the like can select XML data to be preferentially reflected to the index 66, resulting in great convenience.

A selection input screen of XML data that are objects of index reflection displayed by the management program 270 on the basis of the list transmitted by the reflection document selection part 260 will now be described with reference to FIG. 15. FIG. 15 is a diagram showing an example of a selection input screen of XML data that are objects of index reflection in the fifth embodiment. The selection input screen is displayed on an output device of the terminal device 204.

The selection input screen of XML data that are objects of index reflection has, for example, a configuration including a selection input column for specifying whether to set index reflection on XML data and a structure analysis information display column every data ID (data identifier) of XML data as shown in FIG. 15. As a result, the system designer or the like can refer to structure analysis information and select XML data that is an object of index reflection. For example, index reflection is set for XML data having “2” and “4” as the data ID on the screen exemplified in FIG. 15. In other words, XML data respectively having data IDs “2” and “4” are selected as objects of index reflection.

The system manager performs selection input of XML data that should become objects of index reflection via an input device in the terminal device 204 while watching the screen, and performs selection input of an execution button. The management program 270 transmits information selected on the screen to the database management system 10D via the information network 206.

Data IDs and structure analysis information of XML data that are index reflection objects are displayed on the screen. However, this is not restrictive. For example, a part or the whole of the XML data or the data size of the XML data may be displayed. By conducting such display, it becomes easier for the system manager or the like to select XML data as the objects of index reflection.

### Sixth Embodiment

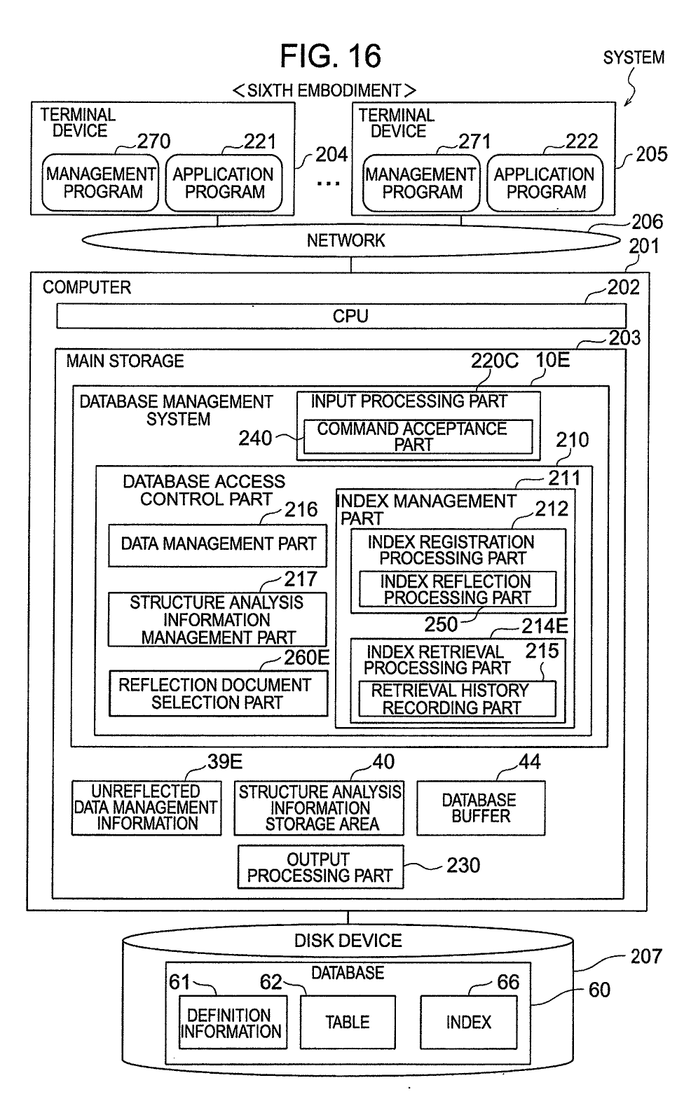

A sixth embodiment of the present invention will now be described. FIG. 16 is a diagram showing a configuration example of a system including a database management system according to the sixth embodiment. The same components as those in the above-described embodiments are denoted by like characters, and description of them will be omitted.

A database management system 10E according to the sixth embodiment records retrieval history of XML data that are not yet reflected to the index. When displaying the selection input screen of XML data which should become objects of index reflection, the management program 270 in the terminal device 204 displays a screen obtained by sorting the XML data on the basis of the retrieval history, or displays the retrieval history itself of the XML data on the screen. The database management system 10E according to the sixth embodiment has such a feature.

The database management system 10E includes a reflection document selection part 260E instead of the reflection document selection part 260 (see FIG. 12). The reflection document selection part 260E transmits a list sorted on the basis of the retrieval history by the index reflection processing part 250 to the management program 270. The list may contain retrieval histories of respective XML data. By doing so, the management program 270 can display a selection input screen of XML data including retrieval histories of respective XML data.

An index retrieval processing part 214E includes a retrieval history recording part 215. The retrieval history recording part 215 records retrieval history of unreflected XML data in an unreflected data management information 39E.

The unreflected data management information 39E contains retrieval history of the structure analysis information, besides a data identifier of XML data that is not yet reflected to the index and access information to structure analysis information generated from the XML data.

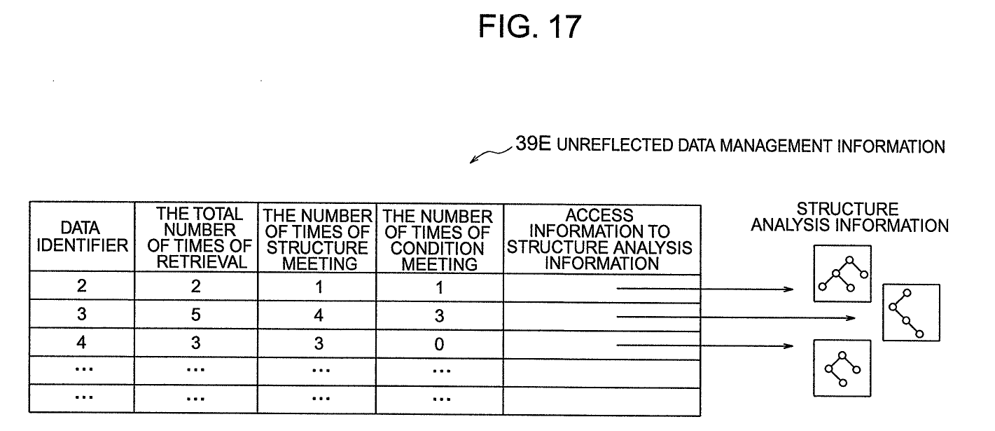

FIG. 17 is a diagram showing an example of unreflected data management information in the sixth embodiment. As shown in FIG. 17, the unreflected data management information 39E contains a data identifier of XML data that is not yet reflected to the index, access information to structure analysis information generated from the XML data, and the total number of times of retrieval, the number of times of structure meeting and the number of times of condition meeting (referred to collectively as retrieval history) of the XML data.

Among them, the total number of times of retrieval indicates the number of times of retrieval of XML data that is a processing object. The value of the total number of times of retrieval is incremented regardless of whether the XML data satisfies a condition specified in the retrieval request. The number of times of structure meeting indicates the number of times a structure specified in the retrieval request exists in the XML data. The number of times of condition meeting indicates the number of times a structure specified in the retrieval request exists in the XML data and a condition specified in the retrieval request (for example, a character string condition) is met.

In the unreflected data management information 39E shown in FIG. 17, XML data respectively having data identifiers “2,” “3” and “4” are not yet reflected to the index. Among them, structure analysis information generated from XML data having “2” as the data identifier is shown to be “2” in the total number of times of retrieval, “1” in the number of times of structure meeting, and “1” in the number of times of condition meeting.

The retrieval history (the total number of times of retrieval, the number of times of structure meeting, and the number of times of condition meeting) in the unreflected data management information 39E is written by the retrieval history recording part 215 each time the index retrieval processing part 214E executes retrieval. By the way, the retrieval history is referred to when the reflection document selection part 260E displays a selection input screen of XML data that are index reflection objects.

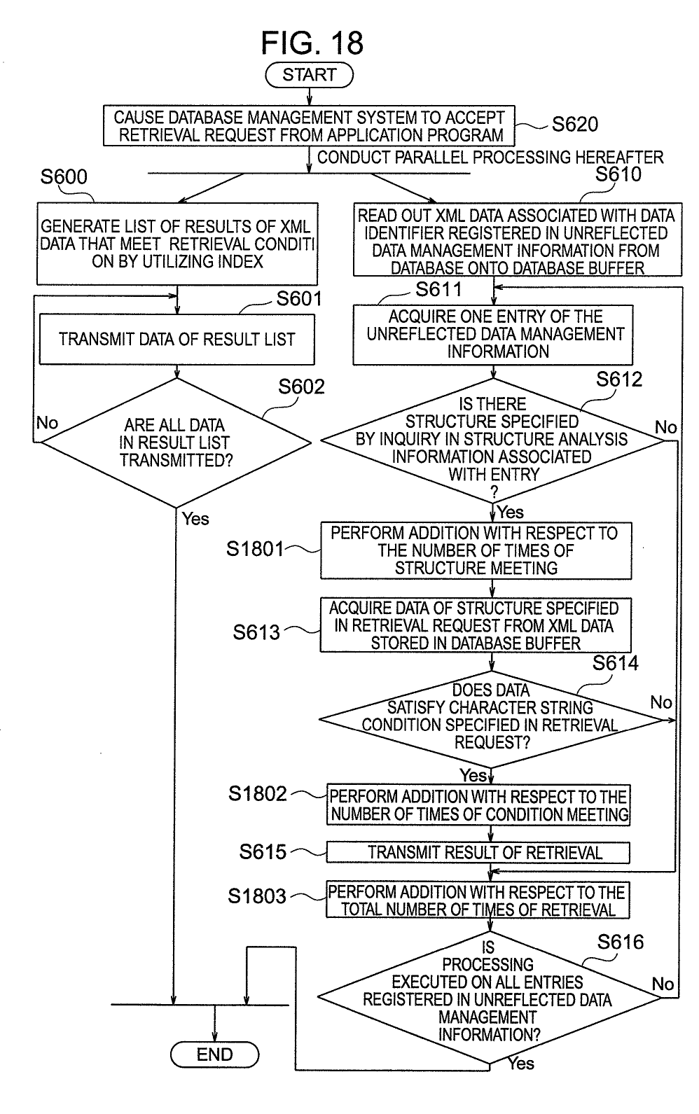

A retrieval history recording procedure of XML data in the sixth embodiment will now be described with reference to FIGS. 6, 16, 17 and 18. FIG. 18 is a flow chart showing an operation procedure followed by the database management system in FIG. 16 at the time of XML data retrieval.

Processing conducted at S620, S600 to S602 and S610 to S612 in FIG. 18 is the same as the processing conducted at S620, S600 to S602 and S610 to S612 in FIG. 6. Therefore, description thereof will be omitted, and description will be started from S1801.

If the index retrieval processing part 214E shown in FIG. 16 judges that a structure specified in the retrieval request exists in structure analysis information that is the processing object (yes at S612), the retrieval history recording part 215 performs addition with respect to the number of times of structure meeting concerning the structure analysis information in the unreflected data management information 39E (see FIG. 17) (S1801). On the other hand, if the index retrieval processing part 214E judges that the structure specified in the retrieval request does not exist in structure analysis information that is the processing object (no at S612), the retrieval history recording part 215 proceeds to S1803.

After S1801, the index retrieval processing part 214E acquires data having a structure specified in the retrieval request from XML data stored in the database buffer 44 in the same way as S613 in FIG. 6 (S613). If the acquired data satisfies a character string condition specified in the retrieval request (yes at S614), the retrieval history recording part 215 performs addition with respect to the number of times of condition meeting concerning the structure analysis information in the unreflected data management information 39E (S1802). On the other hand, if the data acquired at S613 does not satisfy a character string condition (no at S614), the retrieval history recording part 215 proceeds to S1803.

After S1802, the index retrieval processing part 214 transmits a result of the retrieval to the application program 222 in the terminal device 205 in the same way as S615 in the same way as S615 in FIG. 6 (S615). The retrieval history recording part 215 performs addition with respect to the total number of times of retrieval concerning the structure analysis information in the unreflected data management information 39E (S1803).

Since processing conducted at subsequent S616 is the same as the processing conducted at S616 in FIG. 6, description thereof will be omitted.

In this way, the retrieval history recording part 215 records the retrieval history of XML data in the unreflected data management information 39E.

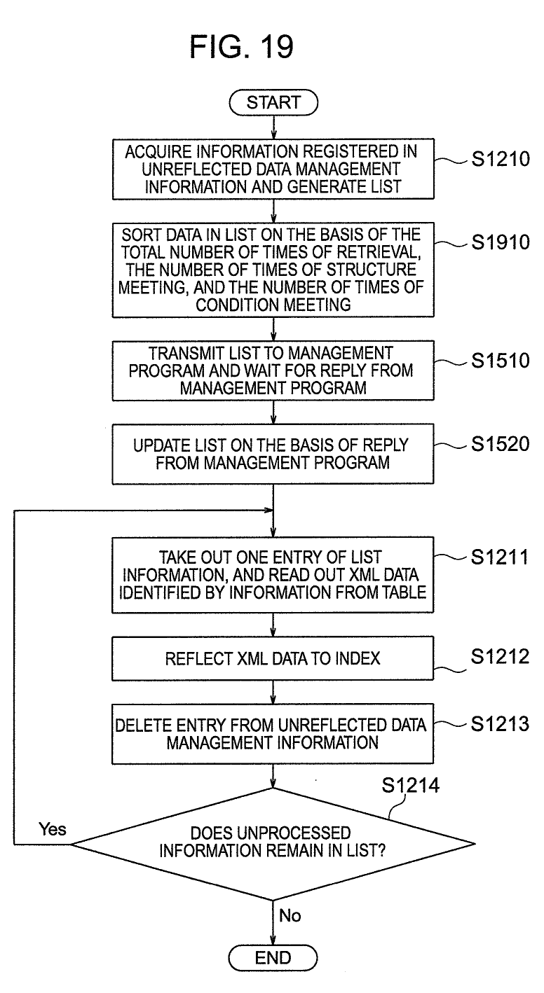

Registration processing of XML data using such retrieval history will now be described. FIG. 19 is a flow chart showing an operation procedure of the database management system shown in FIG. 16.

In the same way as S1210 in FIG. 14 described earlier, the index reflection processing part 250 in FIG. 16 acquires information registered in the unreflected data management information 39E and generates a list (a list of XML data that are not yet reflected to the index) (S1210). And the index reflection processing part 250 sorts data in the list on the basis of the total number of times of retrieval, the number of times of structure meeting, and the number of times of condition meeting (S1910). For example, the index reflection processing part 250 sorts data in the list so as to cause information of XML data that are large in the total number of times of retrieval, the number of times of structure meeting, and the number of times of condition meeting to rank high. Sorting at this time is conducted by using at least one of the total number of times of retrieval, the number of times of structure meeting, and the number of times of condition meeting.

The reflection document selection part 260E transmits a list obtained by data sorting at S1910 to the management program 270 in the terminal device 204, and waits for a reply from the management program 270 (S1510). Since processing conducted at S1520 to S1214 after S1510 is the same as the processing conducted at S1520 to S1214 in FIG. 14, description thereof will be omitted.

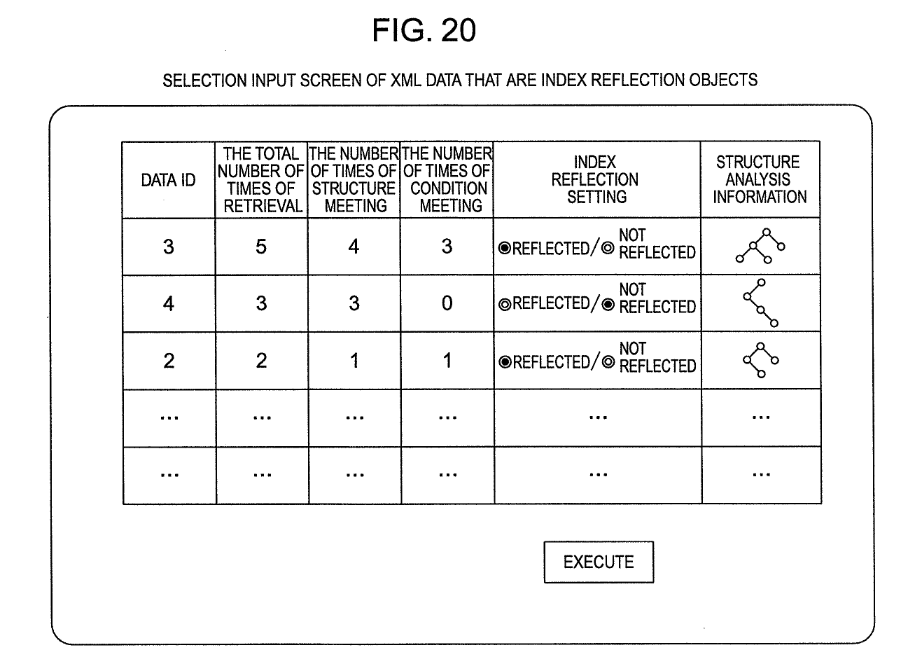

Upon receiving the list transmitted by the reflection document selection part 260E at S1510, the management program 270 causes an output device (not illustrated) in the terminal device 204 to display the selection input screen of XML data to be subject to index reflection. The screen at this time is exemplified in FIG. 20. FIG. 20 is a diagram showing an example of the selection input screen of XML data that are index reflection objects in the sixth embodiment.

As exemplified in FIG. 20, display columns of the total number of times of retrieval, the number of times of structure meeting, and the number of times of condition meeting (retrieval history) of XML data and a display column of structure analysis information are displayed in the selection input screen of XML data that are index reflection objects, besides the data ID of XML data and a selection input column as to whether index reflection should be set in XML data. The data IDs of XML data are sorted and displayed on the basis of the retrieval history. For example, in the screen example shown in FIG. 20, XML data are displayed in the order of data ID “3”→“4”→“2” in the order of decreasing numerical value in the total number of times of retrieval, the number of times of structure meeting, and the number of times of condition meeting.

The database management system 10E causes the management program 270 to display a screen including the retrieval history of XML data or a screen obtained by sorting XML data on the basis of the retrieval history. As a result, it becomes easier for the system manager to find XML data desired to be an object of index reflection more preferentially.

When sorting the list data at S1910, the index reflection processing part 250 may conduct the sorting on the basis of data size, the number of structures and the registration date of the XML data. After the database management system 10E has conducted character string retrieval on XML data, the index reflection processing part 250 may conduct the sorting on the basis of whether there is data that needs postprocessing or the number of times of appearance of the character string in XML data.

By doing so, it becomes easy for the system manager or the like to select XML data that are objects of index reflection.

The reflection of XML data to the index is supposed to be conducted when there is order input from the terminal device 204 or the like. However, the reflection of XML data to the index may be conducted automatically. In other words, when predetermined time is reached or a predetermined number of XML data are stored, the management system 10 or 10A-10E may reflect the XML data to the index 66 automatically.

When predetermined setting input is conducted, the database management system 10 or 10A-10E may conduct index update for all XML data regardless of the processing cost or the like of the XML data. In other words, it is also possible to change over according to setting input whether the database management system 10 or 10A-10E should conduct fast registration processing as described above or should conduct index update on all input XML data.

As for such changeover setting input, a setting processing part (not illustrated) in the database management system 10 or 10A-10E accepts it and records it in the database 60 as setting information. And the database management system 10 or 10A-10E decides which method should be used to conduct index reflection, on the basis of the setting information.

By the way, the setting information may contain various kinds of information concerning the index update. For example, the setting information may contain information such as the size of the database buffer 44, the registration upper limit time in the fast registration processing, or a rule to be used when reflecting XML data to the index 66.

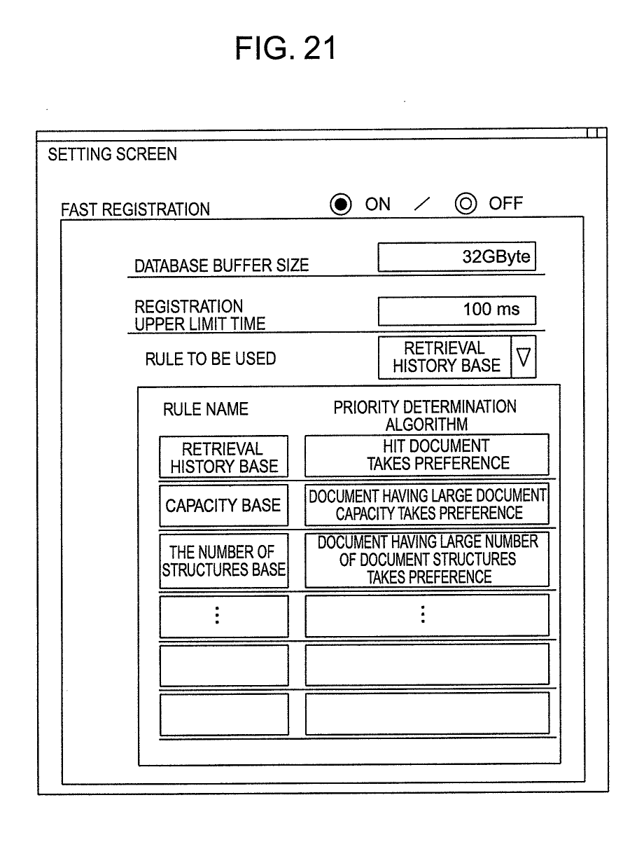

FIG. 21 shows a setting screen example displayed by the setting processing part in the present embodiment. As exemplified in FIG. 21, the setting screen includes radio buttons for selecting whether to conduct fast registration (fast registration processing). The setting screen includes a database buffer size input column to be used when the fast registration has been selected, a registration upper limit time (upper limit value of registration processing time) input column, and a selection column of a rule to be used when reflecting XML data to the index 66 automatically. For example, the setting screen in FIG. 21 shows “ON” selected for fast registration, “32 GByte” selected as the database buffer size, “100 ms” as the registration upper limit time, and “retrieval history base” as the rule to be used.

Information input from the setting screen is transmitted to the database management system 10 or 10A-10E by the management program 270 or the like. The setting processing part in the database management system 10 or 10A-10E reflects the transmitted information to the setting information.

In the setting screen, selection input of an algorithm (priority determination algorithm) to be used in each rule to be used may be accepted.

For example, in the setting screen example shown in FIG. 21, “retrieval history base” is selected as the rule to be used. The rule to be used is shown to use “hit document takes preference” as the priority determination algorithm. In other words, the database management system 10 or 10A-10E records the number of times the XML data meets (hits) the retrieval condition, as retrieval history of the XML data. The database management system 10 or 10A-10E is shown to reflect XML data that is large in the number of times of hit to the index 66 preferentially.

In the setting screen exemplified in FIG. 21, the rule to be used represented as “capacity base” is shown to use “document having large document capacity takes preference” as the priority determination algorithm. In other words, the database management system 10 or 10A-10E is shown to reflect XML data that is large in document capacity (data size) to the index 66 preferentially.

Index update that meets the system requirement of the present system can be conducted by setting whether to conduct fast registration and setting various conditions in conducting the fast registration on the setting screen.

The present invention is not restricted to the embodiments, but modification is possible.

For example, in the third embodiment, the database management system 10B makes a decision whether the registration processing time exceeds the registration upper limit time each time the database management system 10B reflects one structure contained in structure analysis information to the index 66. However, this is not restrictive.

For example, in the case where structures contained in structure analysis information are divided into some groups and index reflection is conducted for each of groups, the database management system may make a decision whether the registration processing time exceeds the registration upper limit time each time reflection of one group to the index 66 is completed.

In addition, in structure analysis information, structures (nodes) are connected to each other by a branch (link) which indicates that those nodes are in an adjacent relation as exemplified in FIG. 10. Therefore, the database management system 10B may make a decision whether the registration processing time exceeds the registration upper limit time each time one link is reflected to a structured index contained in the index 66. In other words, the database management system 10B may make a decision whether the registration processing time exceeds the registration upper limit time, each time the database management system 10B reflects each of a link coupling a node denoted by a numeral 1000 with a node denoted by a numeral 1001 in FIG. 10 and a link coupling the node denoted by the numeral 1000 with a node denoted by a numeral 1003 to the index 66.

If the writing velocity in the disk device 207 is slow, the database management system 10B may update the index 66 as described hereafter. For example, when updating data in the index 66 stored in the disk device 207, the database management system 10B reads out data in the index 66 onto the main storage 203 and updates the index 66 on the main storage 203. And the database management system 10B shifts the updated index 66 to the disk device 207. Each time I/O (Input/Output) processing is conducted to shift the updated index 66 to the disk device 207, the database management system 10B may make a decision whether the registration upper limit time is exceeded. In other words, the database management system 10B updates the index 66 on the main storage 203, and then shifts the updated index 66 on the main storage 203 to the disk device 207 until the registration processing time is exceeded.

By the way, if all of the updated index 66 on the main storage 203 cannot be shifted to the disk device 207, updated index 66 remains on the main storage 203. If in this state it becomes necessary to update the index 66, the index 66 on the main storage 203 is updated. The index 66 can be updated by using such a method as well.

The embodiments have been described by taking the case where the retrieval request of XML data contains a character string condition of XML data that are the retrieval objects as an example. However, this is not restrictive. For example, a condition other than the character string condition such as registration date of XML data that are the retrieval objects may be contained.

In the embodiments, the registration processing and the retrieval processing of XML data are conducted by the same computer 201. However, this is not restrictive. For example, the registration processing of XML data and the update of the index 66, and the retrieval of XML data may be executed by different computers.

The database management system 10 or 10A-10E according to one of the embodiments can be implemented by using a program that causes the above-described processing to be executed. The program can be provided by storing it on a computer-readable storage medium (such as a CD-ROM). It is also possible to provide the program via a network such as the Internet.

It should be further understood by those skilled in the art that although the foregoing description has been made on embodiments of the invention, the invention is not limited thereto and various changes and modifications may be made without departing from the spirit of the invention and the scope of the appended claims.

1. A database management method in a computer for retrieving structured data by using an index concerning at least one structured data, the method comprising the steps of:
accepting input of the structured data and stores the structured data in a storage; conducting structure analysis of the input structured data, and generates structure analysis information containing names of structure elements included in the structured data, relations among the structure elements, and appearance locations, in the structured data, of the structure elements;
calculating a processing cost required to reflect the input structured data to the index on the basis of the generated structure analysis information;
making a decision whether the calculated processing cost exceeds a predetermined threshold;
when the calculated processing cost does not exceed the predetermined threshold, reflecting the structured data to the index;
when the calculated processing cost exceeds the predetermined threshold, not reflecting the structured data to the index, but registering a data identifier of structured data that is not reflected to the index and pointer information for accessing structure analysis information generated on the basis of the structured data, as unreflected data management information in the storage; and
when an input of a retrieval request of the structured data containing a structure condition of the structured data is accepted and structured data that is an object of the retrieval request is structured data that is not reflected to the index,
referring to the unreflected data management information, reading out structured data that is not reflected to the index and structure analysis information generated on the basis of the structured data from the storage, retrieving structure analysis information satisfying the structure condition from the structure analysis information read out, discriminating an appearance location, in the structured data, of a structure element indicated in the structure condition from the retrieved structure analysis information, and retrieving data satisfying the retrieval request from data in the discriminated appearance location.

2. The database management method according to claim 1, wherein the processing cost is registration processing time required to reflect the input structured data to the index, a data size of the structured data, or the number of structure elements contained in the structured data.

3. The database management method according to claim 1, further comprising the step of accepting input of the predetermined threshold from outside.

4. The database management method according to claim 1, further comprising the steps of:
displaying a screen on an output device to urge selection input as to whether to reflect all of the input structured data to the index, and
when a command is input on the screen to reflect all of the input structured data to the index, reflecting all of the structured data stored in the storage to the index.

5. The database management method according to claim 1, further comprising the steps of:
displaying a screen for accepting selection input of structured data to be reflected to the index including a list of structured data that are not yet reflected to the index, generated on the basis of the unreflected data management information, on an output device,
when the selection input of structured data to be reflected to the index is accepted from the screen, reflecting the selected structured data to the index.

6. The database management method according to claim 5, further comprising the step of:
rearranging the list of structured data that is not yet reflected to the index on the screen by taking at least one of retrieval history, a data size, and the number of structure elements of the structured data as a reference.

7. A database management method in a computer for retrieving structured data by using an index concerning at least one structured data, the method comprising the steps of:
accepting input of the structured data and storing the structured data in a storage;
conducting structure analysis of the input structured data, and generating structure analysis information containing names of structure elements included in the structured data, relations among the structure elements, and appearance locations, in the structured data, of the structure elements;
continuing processing of reflecting the generated structure analysis information to the index until a predetermined time elapses;
registering a data identifier of structured data that is not reflected to the index and pointer information for accessing structure analysis information generated on the basis of the structured data, as unreflected data management information in the storage; and
when an input of a retrieval request of the structured data containing a structure condition of the structured data is accepted and structured data that is an object of the retrieval request is structured data that is not reflected to the index,
referring to the unreflected data management information, reading out structured data that is not reflected to the index and structure analysis information generated on the basis of the structured data from the storage, and
referring to the structure analysis information thus read out, discriminating an appearance location, in the structured data, of a structure element satisfying the structure condition, and retrieving data satisfying the retrieval request from data in the discriminated appearance location included in the structured data read out.

8. A database management apparatus for retrieving structured data by using an index concerning at least one structured data, the database management apparatus comprising:
an input processing part for accepting input of the structured data and storing the structured data in a storage;
an index registration processing part for conducting structure analysis of the input structured data, generating structure analysis information containing names of structure elements included in the structured data, relations among the structure elements, and appearance locations, in the structured data, of the structure elements, calculating a processing cost required to reflect the input structured data to the index on the basis of the generated structure analysis information, making a decision whether the calculated processing cost exceeds a predetermined threshold, reflecting the structured data to the index when the calculated processing cost does not exceed the predetermined threshold, preventing reflecting the structured data to the index when the calculated processing cost exceeds the predetermined threshold;
a structure analysis information management part for registering a data identifier of structured data that is not reflected to the index and pointer information for accessing structure analysis information generated on the basis of the structured data, as unreflected data management information in the storage; and
an index retrieval processing part responsive to an input of a retrieval request of the structured data containing a structure condition of the structured data being accepted and structured data that is an object of the retrieval request being structured data that is not reflected to the index, for referring to the unreflected data management information, reading out structured data that is not reflected to the index and structure analysis information generated on the basis of the structured data from the storage, retrieving structure analysis information satisfying the structure condition from the structure analysis information read out, discriminating an appearance location, in the structured data, of a structure element indicated in the structure condition from the retrieved structure analysis information, and retrieving data satisfying the retrieval request from data in the discriminated appearance location.
